(19) United States
(12) Patent Application Publication
(10) Pub. No.: US 2026/0051021 A1
(43) Pub. Date: Feb. 19, 2026

(54) GEOMETRIC UPSAMPLING

(71) Applicant: QUALCOMM Incorporated, San Diego, CA (US)

(72) Inventor: Jamie Menjay LIN, San Diego, CA (US)

(21) Appl. No.: 18/803,323

(22) Filed: Aug. 13, 2024

(51) Int. Cl. G06T 3/4046; G06T 7/00; G06T 7/20

(52) U.S. Cl. CPC G06T 3/4046; G06T 7/20; G06T 7/97; G06T 2200/04; G06T 2207/10016; G06T 2207/10024; G06T 2207/10028; G06T 2207/10048; G06T 2207/10132; G06T 2207/20016; G06T 2207/20081; G06T 2207/20084

(57) ABSTRACT

Certain aspects of the present disclosure provide techniques for upsampling input data including inputting input data at a first resolution into a machine learning (ML) model comprising a plurality of selectivity kernels, each of the plurality of selectivity kernels configured to perform a different type of selectivity to upsample the input data; and obtaining output data, corresponding to the input data, at a second resolution, from the ML model, the second resolution being higher than the first resolution, wherein the output data is based on a composite of outputs from the plurality of selectivity kernels.

### INTRODUCTION

### Field of the Disclosure

Aspects of the present disclosure relate to upsampling, and more particularly, to techniques for performing geometric upsampling.

### Description of Related Art

Disparity estimation can be performed for tasks, such as depth estimation, optical flow estimation, etc., of a scene based on multiscopic (e.g., stereo) images corresponding to multiscopic views of the scene. In particular, disparity estimation (e.g., stereo matching) may refer to the process of finding pixels in multiscopic images that correspond to the same 3D point in the scene, and then computing the distance between matching pixels. The result of performing disparity estimation may be a disparity map. A disparity map may be a 2D map that indicates the horizontal displacement between matching pixels in two or more multiscopic images. For example, assuming stereo images representing a left image and a right image of a scene, a first pixel of the left image may be matched to a first pixel of the right image, as corresponding to the same 3D point in the scene (e.g., the same point of an object). The first pixel in the left image may have a coordinate (x₁, y) and the first pixel in the right image may have a coordinate (x₂, y). The disparity map, accordingly, may indicate that for the first pixel, the horizontal displacement is x₁-x₂.

Performing disparity estimation on higher resolution multiscopic images may be more computationally expensive (e.g., utilize more computational complexity, require a larger memory footprint, cause increased power consumption, and/or lead to higher latency in performing disparity estimation), as compared to performing disparity estimation on lower resolution multiscopic images. In particular, a higher resolution image has more pixels to match and generally requires more calculations to calculate pixel displacements. Therefore, for certain use cases, performing disparity estimation on higher resolution multiscopic images may not be feasible, such as where low latency is required and/or there are computational, power, and/or memory constraints.

However, in some cases, it may be useful to more granularly perform disparity estimation (also referred to as performing higher resolution disparity estimation) for a scene. In particular, if lower resolution multiscopic images of a scene are used, each pixel of the images may represent a larger portion of the scene, such that the resultant disparity map has a low resolution, in that each point of the disparity map represents a relatively large portion of the scene, thereby losing disparity information for finer details of the scene.

Accordingly, there is a technical problem with respect to how to perform higher resolution disparity estimation for a scene with lower latency, lower computational complexity, lower power, and/or lower memory use.

One approach to producing higher resolution disparity estimation for a scene without using higher resolution images of the scene is to utilize disparity upsampling, which is a technique whereby lower resolution multiscopic images can be utilized to generate higher resolution disparity maps. For example, disparity estimation may be performed using multiscopic images of the scene at a lower resolution (e.g., a first resolution). The resultant disparity map may accordingly have a lower resolution (e.g., the first resolution). In certain aspects, the disparity map may be upsampled using a type of disparity upsampling. In such disparity upsampling, the lower resolution disparity map is upsampled to a higher resolution disparity map (e.g., a second resolution), such that each point in the higher resolution disparity map then represents a more granular portion of the scene.

Performance of such disparity upsampling may be more efficient than performing disparity estimation using multiscopic images of the scene at the higher resolution (e.g., the second resolution). In particular, performing disparity estimation using multiscopic images of the scene at the higher resolution may also result in the higher resolution disparity map.

However, the accuracy of a higher resolution disparity map of a scene based on disparity upsampling of a lower resolution disparity map (meaning performing disparity estimation on a lower resolution image, and performing disparity upsampling on the lower resolution disparity map) may be less than the accuracy of a higher resolution disparity map of the scene based on disparity estimation on a higher resolution image. In particular, typical disparity upsampling may utilize standard upsampling methods, such as bilinear interpolation or transposed convolution, which generally treat all points (e.g., corresponding to pixels of the multiscopic images) of the disparity map equally and often do not consider the spatial and temporal relationships between them, leading to suboptimal performance.

For example, such standard upsampling may be useful for photographic upsampling. However, upsampling for disparity estimation may have different goals compared to photographic upsampling. Photographic upsampling focuses on pixel characteristics in images that are intensity-centric, aiming to enhance the visual quality of the images for human perception. In contrast, upsampling for disparity estimation may work with dense disparity maps that carry geometry-centric information, indicating geometric meanings such as uni-directional (left-to-right) 1D distances for stereo depth and bi-directional (X, Y) 2D Euclidean distances for optical flow. Disparity upsampling requires geometric understanding and has different goals compared to photographic upsampling. More generally, upsampling of D-dimensional data that carries geometry-centric information, which may be referred to as geometric upsampling, may have different goals compared to photographic upsampling.

Accordingly, there is technical problem with respect to how to perform higher accuracy geometric upsampling.

Another technical problem is that current disparity estimation techniques are not able to automatically select between performance of disparity upsampling (e.g., according to techniques discussed herein and/or traditional upsampling techniques) based on lower resolution multiscopic images to produce a higher resolution disparity map and performance of disparity estimation on higher resolution multiscopic images to produce the higher resolution disparity map. For example, in some cases, the additional accuracy of performing disparity estimation on higher resolution multiscopic images to produce the higher resolution disparity map may be justified, even though it may be more computationally expensive, while in other cases it may not be. Current techniques may always do one or the other, regardless of what is better for the particular case, thereby resulting in either unnecessary computational complexity in some cases, or poor accuracy in some cases.

### SUMMARY

One aspect provides a method for upsampling input data. The method includes inputting the input data at a first resolution into a machine learning (ML) model comprising a plurality of selectivity kernels, each of the plurality of selectivity kernels configured to perform a different type of selectivity to upsample the input data; and obtaining output data, corresponding to the input data, at a second resolution, from the ML model, the second resolution being higher than the first resolution, wherein the output data is based on a composite of outputs from the plurality of selectivity kernels.

Another aspect provides a method for performing disparity estimation. The method includes determining to perform standalone disparity estimation or disparity upsampling based disparity estimation of the scene based on the complexity of the scene; and performing disparity estimation of the scene based on the determination.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example multi-factor selectivity (MFS) kernel for upsampling low-resolution features in accordance with aspects of the present disclosure.

FIG. 2 depicts an example diagram illustrating details directed to applying selectivity kernels to upsample low-resolution features in accordance with aspects of the present disclosure.

FIG. 3 depicts an example multi-factor selectivity kernel-based upsampling approach in accordance with aspects of the present disclosure.

FIG. 4 depicts an example training process for obtaining parameters of the multi-factor selectivity kernels using training data and ground truth labels in accordance with aspects of the present disclosure.

FIG. 5 depicts an example directed to determining to perform standalone disparity upsampling or disparity upsampling based disparity estimation in accordance with aspects of the present disclosure.

FIG. 6 depicts an example use case directed to performing standalone disparity upsampling or disparity upsampling based disparity estimation in accordance with aspects of the present disclosure.

FIG. 7 illustrates an example artificial intelligence (AI) architecture that may be used for AI-enhanced wireless communications.

FIG. 8 illustrates an example AI architecture of a first wireless device that is in communication with a second wireless device.

FIG. 9 illustrates an example artificial neural network.

FIG. 10 depicts an example method for geometric upsampling in accordance with aspects of the present disclosure.

FIG. 11 depicts an example method for geometric upsampling in accordance with aspects of the present disclosure.

FIG. 12 depicts aspects of an example processing system.

FIG. 13 depicts aspects of an example processing system.

### DETAILED DESCRIPTION

Aspects of the present disclosure are directed to techniques for geometric upsampling, such as disparity upsampling. For example, certain aspects herein provide techniques for improved disparity upsampling that may lead to a more accurate higher resolution disparity map of a scene. Though certain aspects are discussed with respect to disparity upsampling for upsampling of disparity maps, in certain aspects the techniques herein may similarly be used for other types of geometric upsampling.

In particular, certain aspects provide a multi-factor selectivity kernel for a machine learning (ML) model configured to perform geometric upsampling, such as disparity upsampling. In particular, certain aspects herein provide an ML model configured to utilize a composite of a plurality of kernels (referred to as a multi-factor selectivity kernel) for performance of geometric upsampling. In particular, in some cases, selectivity may provide higher accuracy for geometric upsampling, such as disparity upsampling.

Selectivity may be understood as a selectivity (e.g., weighting) of features of a lower resolution data set for determination (upsampling) of features at a higher resolution. For example, assume a feature set having a number of features, each feature corresponding to a D-dimensional coordinate or point in feature space. In an example, the feature space may be a 2D feature space, such as corresponding to a 2D disparity map. Further, each feature may be the displacement value for the associated point/coordinate in the 2D disparity map. In an example, the 2D feature space may be a 3×3 space, such that the 2D disparity map has 3×3 coordinates, corresponding to 9 features associated with 9 matching pixels of multiscopic images. In an example, geometric upsampling of the 3×3 disparity map to a 6×6 disparity map may be performed. Accordingly, the 9 features, as in displacement values, of the 3×3 disparity map may be used to determine the 36 features, as in displacement values, of the 6×6 disparity map. Selectivity may indicate how, for each of the 36 features of the 6×6 disparity map, the 9 features of the 3×3 disparity map are used to determine the feature (e.g., displacement value). For example, for determining a particular feature of the 6×6 disparity map, different types of selectivity may apply different weights/functions to each of the 9 features of the 3×3 disparity map, thereby resulting in different values for the feature.

In certain aspects, different kernels of the multi-factor selectivity kernel may be configured to perform different types of selectivity for performance of geometric upsampling. Further, the multi-factor selectivity kernel may take a composite (e.g., normalized addition, normalized multiplication, and/or other function) of the outputs of the different kernels to determine the feature value for each feature of the higher resolution feature set. For example, each kernel may output its own feature value for each feature. In certain aspects, by utilizing multiple different kernels to perform the geometric upsampling, selectivity based on multiple different factors (e.g., feature similarity, spatial distance, geometric consistency, temporal consistency, estimation confidence, etc.) may be taken into account, which may provide more robust and accurate geometric upsampling. In certain aspects, the multi-factor selectivity kernel comprises a plurality of kernels, such as two or more of a feature similarity kernel (FSK), spatial distance kernel (SDK), geometric consistency kernel (GCK), temporal consistency kernel (TCK), or estimation confidence kernel (ECK).

In certain aspects, the FSK measures the similarity between features in the latent feature space, while the SDK captures the Euclidean distance between features. The GCK can assess the geometric consistency of features, and the TCK can evaluate the temporal consistency of features across frames. Finally, in some aspects, the ECK quantifies the confidence of the estimated features, providing a dense estimation confidence map. For example, the FSK can help prioritize pixels with similar features, as they are more likely to belong to the same object or surface. The SDK can assign higher weights to nearby pixels, as they are more likely to have similar disparities. The GCK can favor pixels that maintain consistent geometric structures, such as edges or contours. The TCK can prioritize pixels that exhibit consistent motion or disparity patterns across frames. The ECK can assign higher weights to pixels with more reliable or confident disparity estimates. By considering these spatial and temporal relationships, the kernels enable the geometric upsampling process to allocate more weight to the more likely relevant features.

In certain aspects, the multi-factor selectivity kernel may involve multi-modality. For example, features of the feature set may come from multiple different modalities (e.g., corresponding to different sensors). In certain aspects, features from different modalities may be input into different kernels of the multi-factor selectivity kernel. For example, features from a first camera may be input into a first kernel, and features from a second camera may be input into a second kernel. The composite of the outputs of the kernel may be used for the geometric upsampling. Accordingly, a technical benefit of using multiple modalities for improved geometric upsampling may be had in certain aspects.

In certain aspects, instead of a multi-factor selectivity kernel, one of GCK, TCK, or ECK may be used for geometric upsampling, which may provide improved accuracy over traditional upsampling.

In certain aspects, techniques are provided for automatically selecting between performance of disparity upsampling (e.g., according to techniques discussed herein and/or traditional upsampling techniques) based on lower resolution multiscopic images to produce a higher resolution disparity map (also referred to as disparity upsampling based disparity estimation) and performance of disparity estimation on higher resolution multiscopic images to produce the higher resolution disparity map (also referred to as standalone disparity estimation).

For example, in some types of scenes, such as scenes with simple shapes, accuracy of disparity upsampling based disparity estimation may be high. In some other types of scenes, such as scenes with complex shapes, accuracy of disparity upsampling based disparity estimation may be low. Accordingly, certain aspects provide techniques for selecting between disparity upsampling based disparity estimation and standalone disparity estimation, based on a complexity of the scene (e.g., as determined using the lower resolution multiscopic images).

In some cases, techniques are provided for selecting between disparity upsampling based disparity estimation and standalone disparity estimation dynamically at different pyramid levels of a disparity estimation process. For example, for a given frame (e.g., of a set of frames each frame corresponding to a point in time of the scene), disparity estimation may be performed for multiscopic images corresponding to the frame at each of multiple different resolutions, each resolution referred to as a pyramid level. The type of disparity estimation performed (e.g., disparity upsampling based disparity estimation or standalone disparity estimation) may be different for different pyramid levels of the frame. Further, different frames may have different types of disparity estimation performed for the same pyramid levels. The selection may also be based on complexity of the scene.

Pyramid levels, in the context of image processing and computer vision, refer to the different scales or resolutions of features. For example, a pyramid representation of an image may be constructed by recursively downsampling the image, creating a series of images with progressively lower resolutions. In such an example, the original image is considered the highest resolution level (or the finest scale), and each subsequent level has a lower resolution than the previous one. The process of moving from a lower resolution to a higher resolution is called upsampling, while the process of moving from a higher resolution to a lower resolution is called downsampling.

In an example, a pyramid representation of an image with an original resolution of 1024×768 pixels may include the following levels:
Level 0: 1024×768 pixels (original resolution)
Level 1: 512×384 pixels
Level 2: 256×192 pixels
Level 3: 128×96 pixels

In this example, Level 0 represents the highest resolution (finest scale), while Level 3 represents the lowest resolution (coarsest scale). The disparity estimation and disparity upsampling processes can be applied at different pyramid levels depending on a desired accuracy and computational efficiency.

In certain aspects, it may be more efficient to perform standalone disparity estimation at lower pyramid levels (coarser scales) and then geometrically upsample the results to higher pyramid levels (finer scales), while in other cases, it may be better to perform standalone disparity estimation directly at higher pyramid levels.

For example, in scenes with low spatial complexity or slow-moving objects, disparity upsampling based disparity estimation may be used, reducing the computational cost and latency. Conversely, in scenes with high spatial complexity or fast-moving objects, standalone disparity estimation may be used at multiple pyramid levels to capture fine details and maintain high accuracy. This adaptive approach may allow for a more efficient allocation of computational resources.

In some aspects, dynamic switching mechanism can be realized through a decision module that assesses the spatial and temporal characteristics of the input data and determines a (e.g., optimal) processing strategy for each pyramid level and/or frame. This decision module can be learned during a training process, allowing the decision module to adapt to specific requirements and constraints of the target application.

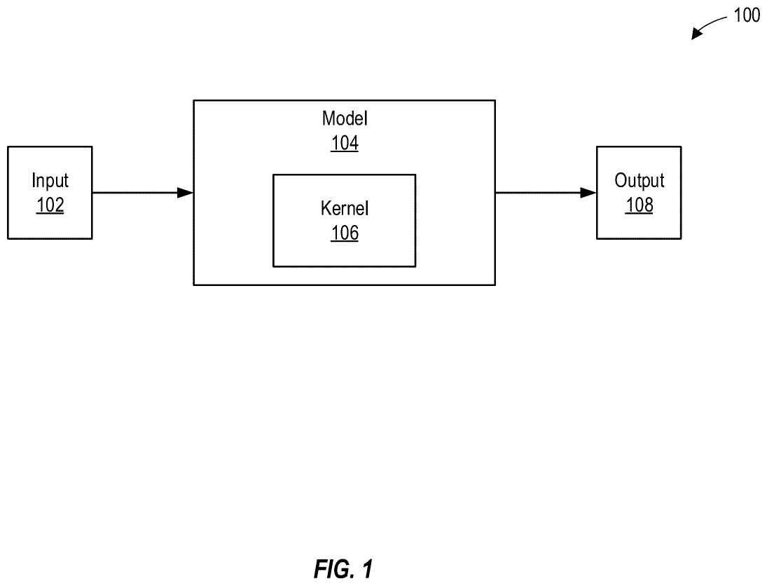

FIG. 1 depicts a system 100 for upsampling input data in accordance with aspects of the present disclosure. In some examples, the system 100 may be implemented in a device such as a vehicle, an extended reality (XR) device, a mobile device, or any other suitable computing device or system.

In some aspects, the system 100 includes input data 102 received at a first resolution. In certain aspects, the input data 102 may include a disparity map (e.g., corresponding to depth data, optical flow data, etc.) of image data, video data, depth data, audio data, or any other suitable type of data. The input data 102 may be captured by one or more sensors, or based on data captured by one or more sensors, coupled to the system 100, such as cameras, depth sensors, etc. For example, multiscopic images (e.g., at a lower resolution) may be captured by one or more sensors, and a lower resolution disparity map generated (e.g., using another ML model) based on the multiscopic images. In some examples, the input data 102 may be received from a storage device or memory coupled to the system 100.

In certain instances, the input data 102 may include data at various resolutions and in different pyramid levels. In some aspects, the input data 102 may be organized into a pyramid structure, where each level of the pyramid represents the data at a different resolution. The pyramid structure may allow the system 100 to process the input data 102 at multiple scales, which can improve the efficiency and accuracy of the upsampling process.

In some examples, the input data 102 can include a low resolution version of the data, such as a disparity map at a quarter resolution (e.g., half the width and half the height of the original image to which the disparity map corresponds). The low resolution data may serve as the base level of the pyramid, providing a coarse representation of the input data 102. In some aspects, the input data 102 may include data at intermediate resolutions, such as half resolution (e.g., half the width or half the height of the original) or full resolution (e.g., the same width and height as the original). Intermediate resolution levels can provide additional detail and information that can be used to guide the upsampling process. For example, the one or more selectivity kernels 106 may compare the intermediate resolution data to the upsampled low resolution data to enforce consistency and reduce artifacts.

In some aspects, the input data 102 may include additional types of data, such as depth data (e.g., from LiDAR), audio data, image data (e.g., including optical flow data based on image data), Radio Frequency (RF) data (which may be related to wireless signals such as for WiFi, Bluetooth, NFC, or 5G/6G), Ultrasonic data, or Infra-red data, etc. These additional data types provide information about the 3D structure and motion of the scene, which can be used to improve the accuracy and consistency of the upsampling process. For example, depth data may be used to enforce geometric consistency in the upsampled output 108, while optical flow data may be used to enforce temporal consistency across frames.

In some aspects, the input data 102 can be provided to a machine learning (ML) model 104 that may upsample input data 102 and generate output 108 having a resolution that is greater than input data 102. The ML model 104 may be used to learn the complex mapping between the low resolution input data 102 and the desired high resolution output 108. By using a learning-based approach, the ML model 104 can capture and exploit patterns and relationships in the input data 102 that may be difficult to model explicitly.

The ML model 104 may include one or more selectivity kernels 106. In some aspects, the one or more selectivity kernels 106 may be referred to as an MFS Kernel. In some aspects, each kernel of the one or more selectivity kernels 106 may be configured to perform a different type of selectivity for upsampling the input data 102. By utilizing one or more selectivity kernels 106, each focused on a different selectivity criteria, the ML model 104 can upsample the input data 102 to produce a higher quality, higher resolution output.

In some examples, the one or more selectivity kernels 106 may include one or more GCKs. A GCK may evaluate the geometric consistency between the input data 102 and an upsampled version of the input data 102. This allows the GCK to enforce geometric consistency during the upsampling process, reducing artifacts and improving the final output. In some aspects, the GCK operates on a disparity space of the input data 102.

In some aspects, the one or more selectivity kernels 106 may also include one or more temporal consistency kernels (TCKs). A TCK may evaluate the consistency of the input data 102 across a temporal sequence of frames. In certain aspects, this allows the TCK to enforce temporal smoothness during the upsampling process, reducing flickering and other temporal artifacts in the output video sequence. In some examples, the TCK compares the similarity of upsampled pixels or regions across adjacent frames to measure temporal consistency.

In some aspects, the one or more selectivity kernels 106 may include an estimation confidence kernel (ECK). In some aspects, the ECK may evaluate the reliability or confidence of the upsampling at each pixel or region. In some aspects, the ECK can modulate the upsampling based on the reliability of the estimation in different areas. For example, the ECK may assign a higher weight to high confidence regions, using those to guide the upsampling in lower confidence regions. In some examples, the estimation confidence is based on the magnitude of the disparity gradient.

The output of the one or more selectivity kernels 106 can be combined to produce an output 108 from the ML model 104. In some aspects, the output 108 may comprise a high resolution version of the input data 102, where the resolution of the output 108 is greater than the resolution of the input data 102. In some examples, the output 108 may have twice the width and twice the height of the input data 102, for an overall 4× increase in resolution. Higher upsampling factors are also possible, such as 8× or 16×. The output 108 may be in the same format as the input data 102, such as a disparity map. In some examples, the output 108 may also include additional channels or information, such as a confidence map for example. These additional channels can provide information about 3D structure, motion, and reliability of the upsampled data, which may be used by a downstream processing application.

The quality of the output 108 can depend on several factors, including the quality of the input data 102, the complexity of the scene, and the effectiveness of the ML model 104 and one or more selectivity kernels 106. In general, the output 108 may be sharper, more detailed, and more consistent than the low resolution input data 102. However, there may be some limitations or artifacts in the output 108, particularly in challenging regions such as occlusions, thin structures, or fast-moving objects.

To evaluate the quality of the output 108, various metrics can be used, such as peak signal-to-noise ratio (PSNR), structural similarity index (SSIM), or mean squared error (MSE). These metrics may provide objective measures of the similarity between the upsampled output 108 and a reference high resolution disparity map. Subjective evaluations, such as visual inspection by experts or user studies, can also be used to assess the perceptual quality of the output 108 and maybe useful when training the ML model 104.

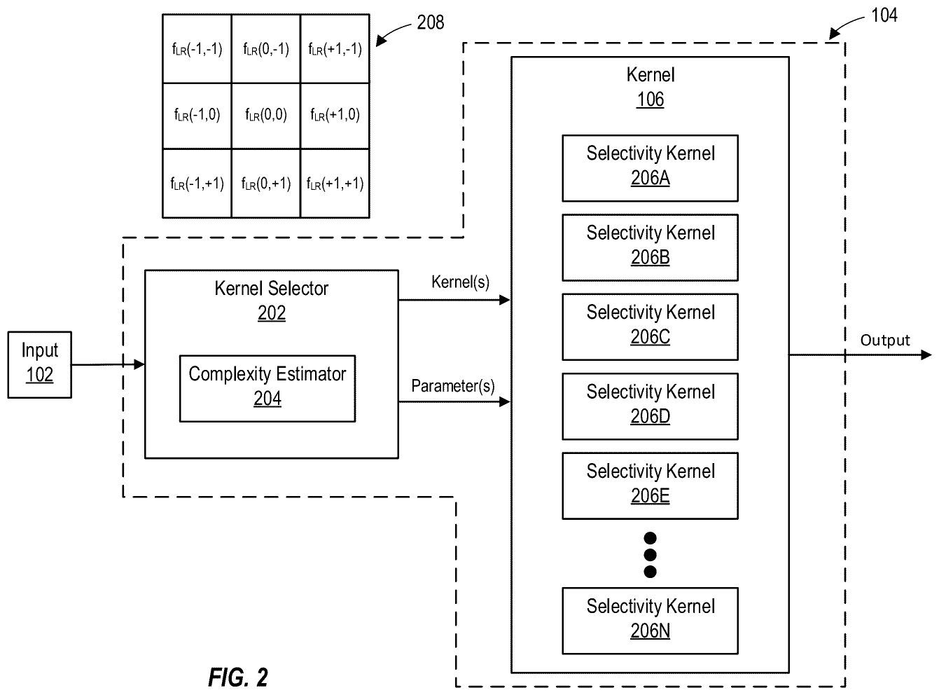

FIG. 2 depicts additional details of the ML model 104 in accordance with aspects of the present disclosure. In certain aspects, the ML model 104 can receive the input data 102 and process the input data 102 using the one or more selectivity kernels 106, which may comprise a plurality of selectivity kernels 206A-N, to generate the output 108 having a greater resolution than the input data 102. The one or more selectivity kernels 106 can operate to enhance the selectivity of the ML model 104 for geometric upsampling by combining multiple normalized multiplicative kernel components, each serving an independent role in arithmetically qualifying or disqualifying features in a defined kernel region.

In certain aspects, one or more selectivity kernels 106 may be referred to as a multi-factor selectivity kernel (MFS) and can be expressed as:

K_{MFS}(x)=πKᵢ(x), from i=1, . . . , m, where x=[x₁, xₛ, . . . , x_{D}] is a D-dimensional coordinate in the feature space, m≥1, and 0≤Kᵢ≤1. Each Kᵢ may be a normalized multiplicative kernel component of K_{MFS}, and Kᵢ and Kⱼ may be orthogonal for i≠j. In some aspects, the ML model 104 may employ m≥3 kernel components.

In some cases where an additive component is utilized for K_{MFS}, the ML model 104 may apply a kernel template to support such non-multiplicative properties. For example, assuming s(x) and t(x) have an additive arithmetic relation in evaluation for selectivity, the i-th kernel component may be defined as: Kᵢ(x)=(s(x)+γt(x))/∥s(x)+γt(x)∥ₚ, where y is a scaler and ∥·∥ₚ is a p-norm to normalize Kᵢ in [0,1]. Examples of p may include 1 or 2.

In certain aspects, each selectivity kernel 206A-N independently qualifies or disqualifies features in a defined kernel region, such as in a 3×3 region (e.g., 208). The upsampled high-resolution feature f_{HR} can be computed as:

$${f}_{HR} = \frac{1}{Norm} {\sum }_{( i , j ) ∈ Λ} {f}_{LR} ( i , j ) * {K}_{MFS} ( i , j ) \qquad Equation 1$$

$${f}_{HR} = \frac{1}{Norm} {\sum }_{( i , j ) ∈ Λ} {f}_{LR} ( i , j ) * π {K}_{z} ( i , j ) , ( from z = 1 , ... , m ) \qquad Equation 2$$

$${f}_{HR} = \frac{1}{Norm} {\sum }_{( i , j ) ∈ Λ} {f}_{LR} ( i , j ) * {K}_{1} ( i , j ) * {K}_{2} ( i , j ) * ... {K}_{m} ( i , j ) \qquad Equation 3$$

where f_{HR} denotes the upsampled high-resolution feature, f_{LR} denotes the (pre-upsampled) low-resolution feature, A denotes the kernel region with (i,j) (e.g., 208) being the coordinates within the region, K denotes the kernel function taking a coordinate in Λ, and Norm is the sum of norms for all the contributing f_{LR} features. In some examples, all norms sum to 1 for contributing f_{LR} features in Λ during upsampling. In some examples, the suitably chosen independent selectivity kernels can lead to higher selectivity of f_{LR} for f_{HR}.

In some aspects, the kernel selector 202 may select an appropriate subset (e.g., one or more, such as one or all) of selectivity kernels 206A-N to be applied to the input data 102. The selection process may be based on characteristics and a complexity of the input data 102, as determined by the complexity estimator 204. In some aspects, the kernel selector 202 may choose a larger subset of selectivity kernels 206A-N for complex input data, such as scenes with multiple objects, textures, or intricate geometric structures. For simpler input data, such as scenes with few objects or smooth surfaces, the kernel selector 202 may choose a smaller subset of selectivity kernels 206A-N.

In certain aspects, the complexity estimator 204 may analyze the input data 102 to determine a complexity and provide this information to the kernel selector 202. The complexity analysis may involve various techniques, such as, but not limited to, examining the spatial and temporal variations in the input data 102, detecting edges and textures, or identifying objects and their relationships. In some examples, the complexity estimator 204 may utilize machine learning techniques, such as convolutional neural networks (CNNs) or support vector machines (SVMs), to learn one or more complexity patterns from a large dataset of input samples. In some aspects, the complexity estimator 204 may assign a complexity score or a set of complexity metrics to each input sample, which the kernel selector 202 can then use to make informed decisions about the selection of selectivity kernels 206A-N.

In some examples, the selectivity kernel(s) 206A-N work together to enhance the quality and accuracy of an upsampled output 108 by considering various factors such as, but not limited to, geometric consistency, temporal consistency, estimation confidence, feature similarity, and spatial distance. For example, as previously described, the GCK 206A may operate to ensure the upsampled output 108 maintains a geometric structure and coherence of the input data 102. The TCK 206B may operate to ensure that the upsampled output 108 maintains temporal stability and smoothness across multiple frames in a video sequence. The ECK 206C may assess the reliability and confidence of the upsampling process at each pixel or feature location in the input data 102. The FSK 206D may measure the similarity between the features in the input data 102 and the upsampled output 108. The SDK 206E may consider spatial relationships and distances between pixels or features in the input data 102 during an upsampling process. In some examples, the kernel selector 202 may provide an indication of one or more subsets of selectivity kernels 206A-206N; in some examples, the kernel selector 202 may provide one or more parameters, configuration settings, or the like to the one or more selectivity kernel 206A-206N for operation. In some examples, a parameter may relate to one or more configurations of the selectivity kernel 206A-206N and/or designate one or more portions of the input data 102 for processing by the one or more selectivity kernels 206A-206N.

As provided in Equations 1-3 above, the selection of one or more independent selectivity kernel(s) 206A-N can lead to higher selectivity of the low-resolution features f_{LR} for the upsampled high-resolution features f_{HR}. This is because each selectivity kernel 206A-N focuses on a different aspect or factor of the upsampling process. By multiplicatively combining the outputs of these kernels, the one or more selectivity kernels 106 can effectively qualify or disqualify the low-resolution features based on multiple criteria, leading to a more selective and accurate upsampling process.

In some aspects, one or more selectivity kernels 206A-N may be associated with one or more kernel regions 208, each responsible for processing a specific part or aspect of the input data 102. The fine-grained association of the selectivity kernels 206A-N allows for a more targeted and adaptive processing of the input data 102, which can lead to better upsampling results.

As previously discussed, the output 108 of the ML model 104 may be a high-resolution version of the input data 102, obtained by applying one or more selected selectivity kernels 206A-N. The upsampled output 108 can then be used for various machine learning tasks, such as object detection, semantic segmentation, or action recognition, which typically utilize high-resolution input data. By providing a high-quality and accurate upsampled output 108, the ML model 104 can improve the performance and reliability of these downstream tasks, enabling a wide range of applications in technologies, such as computer vision, robotics, and autonomous systems.

In accordance with aspects of the present disclosure, the one or more selectivity kernels 106 comprises a plurality of selectivity kernels, each designed to perform a different type of selectivity for upsampling. In some aspects, the FSK measures the similarity between features in the latent feature space, while the SDK captures the Euclidean distance between features. In some aspects, the GCK can be defined based on a downstream geometric tasks. For stereo matching, the GCK may enforce left-right view consistency and can be expressed as:

consistency=e−∥L−R′∥²/σ², where R′=Warp(R, d). In some aspects, L and R refers to left and right feature maps, and d may be the estimated disparity map.

For optical flow, the GCK may enforce motion consistency and can be expressed as: consistency=e−∥L−R′∥²/σ², where F′i=Warp(Fᵢ, f). Fᵢ and Fᵢ₊₁ refer to feature maps of the i^{th} and (i+1)^{th} frames, and f may be an estimated dense flow map. That is, warping for a previous frame may be obtained by applying the quantity of optical flow f, between frame (i) and (i+1) to the feature map Fᵢ at frame (i). The square normalization for the difference between the two feature maps (e.g., the warped Fᵢ at frame (i) and the unwarped Fᵢ₊₁ at frame (i+1) can be obtained. Optical flow consistency may be similar to the stereo matching except that Fᵢ and Fᵢ₊₁ may be used instead of R and L and one dimensional warping is performed instead of two-dimensional warping.

In some aspects, TCK refers to use cases involving video sequences, where TCK may enforce frame-to-frame consistency. In aspects, the TCK may measure the smoothness of estimated geometric disparities using suitably defined measures such as difference (Δ) or standard deviation (σ). The TCK may help to ensure consistency of stereo depth for 3D reconstruction and visual see-through applications.

In some aspects, ECK refers to capturing a confidence or certainty of the upsampling process. In some examples, ECK can use suitably defined measures for “certainty” (or 1-uncertainty) to assess the reliability of the estimated disparities or upsampled features.

By incorporating these different selectivity kernels, the one or more selectivity kernels 106 can perform upsampling while taking into account various spatial, temporal, geometric, and confidence-related factors. In some aspects, the combination of these kernels allows the one or more selectivity kernels 106 to effectively qualify or disqualify features based on multiple criteria, leading to a more accurate and robust upsampling process.

In accordance with aspects of the present disclosure, the selectivity kernel(s) described above may be directed to 2D spatial processing, where the kernel(s) operate on the height (H) and width (W) dimensions of the input data. However, in some instances, these kernel(s) can be extended to operate on 3D coordinates, incorporating depth dimensions or other equivalent 3D linear transformations without 2D projection.

In examples, a 3D spatial selectivity kernel can perform disparity estimation tasks, such as the estimation of scene flow. In some aspects, scene flow represents the dense or sparse coordinate-wise displacements of points in the 3D Euclidean space, capturing the motion and structure of the scene. By extending the selectivity kernel(s) to 3D, the one or more selectivity kernels 106 can process and upsample 3D data, taking into account the spatial relationships and consistencies in all three dimensions.

In some aspects, the TCK can be used in conjunction with the 2D or 3D spatial selectivity kernel(s), providing an additional layer of selectivity that takes into account the temporal relationships of the input data. By incorporating the TCK, the one or more selectivity kernels 106 can perform a more comprehensive and coherent upsampling that preserves the spatial and temporal structures of the input data. For example, the combination of 3D spatial selectivity kernels and the TCK enables the one or more selectivity kernels 106 to handle a wide range of applications and data types, including 3D video, point clouds, and time-series data.

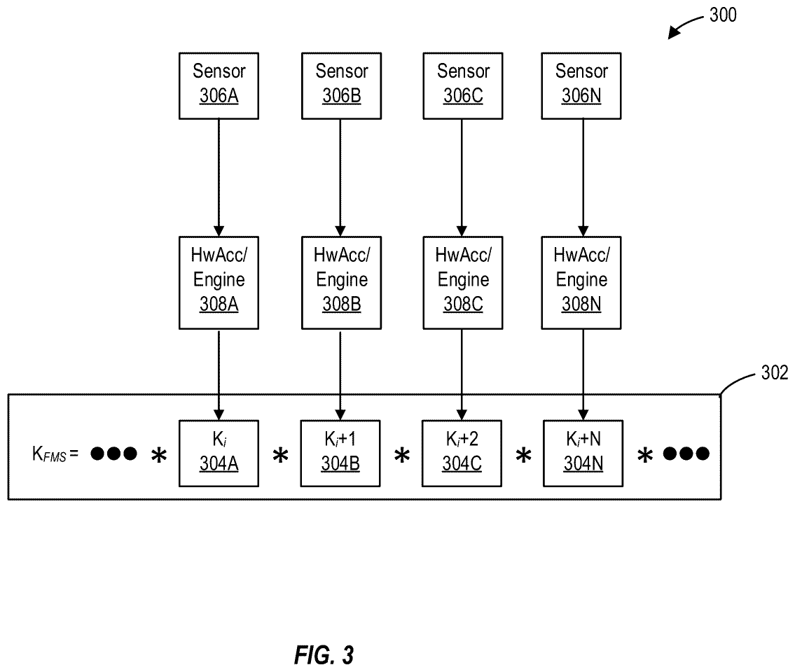

FIG. 3 depicts an example architecture 300 for implementing the one or more selectivity kernels 106 in a hardware accelerator or engine, in accordance with aspects of the present disclosure. In some aspects, the one or more selectivity kernels 106, denoted as K_{FMS} 302 in FIG. 3, may comprise a plurality of individual selectivity kernels 304A-304N, each designed to perform a specific type of selectivity during an upsampling process. In some aspects, the example architecture 300 can include one or more sensors 306A-306N and corresponding hardware accelerators or engines 308A-308N, which work in conjunction with the selectivity kernels 304A-304N to process the input data 102 and generate an output 108 (FIG. 1).

In some aspects, the K_{FMS} 302 may represent the overall one or more selectivity kernels 106, combining the outputs of the individual selectivity kernels 304A-304N in a multiplicative manner. As discussed earlier, the one or more selectivity kernels 106 can be expressed in accordance with Equations 1-3 above.

In some aspects, the selectivity kernels 304A-304N are individual kernel components that focus on different aspects of the upsampling process. For example, each selectivity kernel 304A-304N may qualify or disqualify features in a defined kernel region based on a specific criterion, such as geometric consistency, temporal consistency, estimation confidence, feature similarity, or spatial distance. For instance, the kernel Kᵢ 304A may be a GCK that ensures the upsampled output maintains the geometric structure and coherence of the input data. The kernel Kᵢ₊₁ 304B may be a TCK that ensures the upsampled output maintains temporal stability and smoothness across multiple frames in a video sequence. The kernel Kᵢ₊₂ 304C may be an ECK that assesses the reliability and confidence of the upsampling process at each pixel or feature location. The kernel K_{i+N} 304N may represent any additional selectivity kernels that is part of the one or more selectivity kernels 106.

In some aspects, each selectivity kernel 304A-304N may be implemented as a separate hardware module or block within a hardware accelerator or engine 308. In some instances, these hardware modules may be designed to perform the specific computations and operations of each selectivity kernel, such as convolution, correlation, or similarity measurement. For example, by providing separate hardware resources to each selectivity kernel, the architecture 300 depicted in FIG. 3 can achieve high parallelism and throughput, enabling real-time processing of high-resolution input data.

In some aspects, the sensors 306A-306N may include one or more input devices that capture data (such as raw data) to be processed by the one or more selectivity kernels 106. In some examples, the sensors may include various types of imaging sensors, such as but not limited to, color cameras, depth cameras, infrared cameras, or thermal cameras, depending on the specific application and the nature of the input data. For example, in a stereo vision system, the sensors 306A and 306B may be a pair of color cameras that capture left and right images of a scene, which can be used to estimate the disparity and depth information. In a video surveillance system, the sensors 306A-306N may be a network of color cameras that capture video streams from different viewpoints, which can be used to track objects and detect anomalies. In an autonomous vehicle, the sensors 306A-306N may include a combination of color cameras, depth cameras, and LiDAR sensors that capture comprehensive information about the surrounding environment, which can be used for obstacle detection, lane tracking, and traffic sign recognition.

In some aspects, the sensors 306A-306N may have different resolutions, frame rates, and fields of view, depending on their specific characteristics and the requirements of the application. In some aspects, the raw data captured by the sensors 306A-306N may undergo some pre-processing steps, such as noise reduction, color correction, or calibration, before being fed into the hardware accelerators or engines 308A-308N.

In some aspects, the hardware accelerators or engines 308A-308N may be hardware units that are designed to execute the computations and operations of the selectivity kernels 304A-304N. In some instances, each hardware accelerator or engine 308A-308N can be paired with a corresponding sensor 306A-306N and selectivity kernel 304A-304N, forming a processing pipeline that can operate independently and in parallel with other pipelines. This architecture 300 allows for processing of input data and enables real-time performance in various applications, such as video processing, computer vision, and autonomous systems.

The hardware accelerators or engines 308A-308N may include various types of computing units, such as digital signal processors (DSPs), field-programmable gate arrays (FPGAs), application-specific integrated circuits (ASICs), or graphics processing units (GPUs). In some aspects, these computing units can be optimized for performing the specific types of operations of the selectivity kernels 304A-304N, such as convolution, correlation, similarity measurement, or feature extraction. In some aspects, the hardware accelerators or engines 308A-308N may also include on-chip memory or caches to store the intermediate results and reduce the data transfer overhead between different processing stages.

The hardware accelerators or engines 308A-308N may be programmable or configurable, allowing them to adapt to different types of input data and selectivity kernels. For example, the hardware accelerators or engines 308A-308N may include a set of configurable parameters, such as the kernel size, the number of channels, or the data precision, which can be adjusted based on the specific requirements of the application. This flexibility can enable the architecture 300 to support a wide range of upsampling tasks and, in some instances, to optimize the performance and power efficiency for each specific scenario.

In some aspects, the one or more selectivity kernels 106 may incorporate multi-modal information by processing data from multiple types of sensors. As shown in FIG. 3, the architecture 300 includes one or more sensors 306A-306N, where different sensors may capture a different modality or characteristic of the input data. Examples of the sensors 306A-306N may include, but are not limited to, RGB cameras, depth sensors, LiDAR sensors, time-of-flight (ToF) sensors, and audio sensors. For example, sensor 1 (306A) and Sensor 2 (306B) may represent two RGB cameras that capture stereo image pairs. These stereo images can be used to estimate disparity maps and depth information, which can then be processed by the one or more selectivity kernels 106 (FIG. 1) to generate high-resolution depth maps. The LiDAR/ToF sensor (306C) may provide sparse depth measurements or point clouds, which can be used to guide the upsampling process and improve the accuracy of the estimated depth maps. The audio sensor (306N) may capture ambient sounds or acoustic cues that can provide additional context or semantic information about the scene, such as the presence of objects or events that may not be visible in the image data.

By incorporating data from multiple modalities, the one or more selectivity kernels 106 can leverage complementary information and cross-modal cues to improve the accuracy of the upsampling process. For example, the depth information from the LiDAR/TOF Sensor can be used to constrain the disparity estimation from the stereo cameras, while the audio cues from the Audio Sensor can help disambiguate objects or regions that may be visually similar but semantically different.

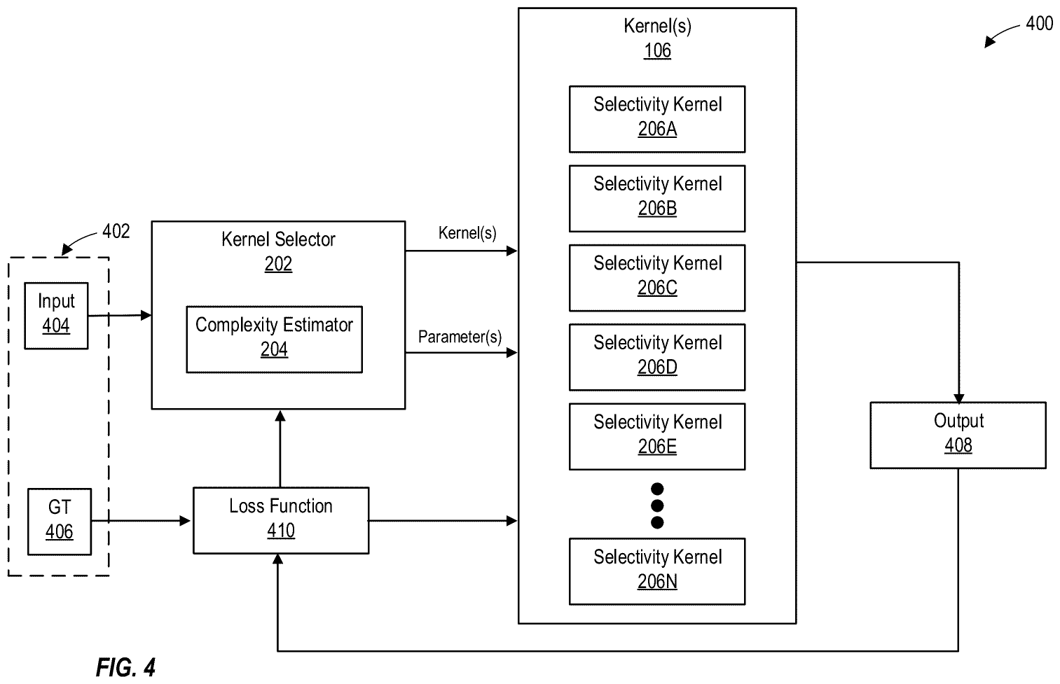

FIG. 4 depicts an example training system 400 for training one or more selectivity kernels 106 used in the one or more selectivity kernels 106, in accordance with aspects of the present disclosure. In some aspects, the training system 400 may include a set of training data 402, which may comprise input data 404 and corresponding ground truth data 406. The input data 404 may be similar to or the same as the input data 102 described in previous figures, while the ground truth data 406 represents a desired output or target for each input sample. The training system 400 may also include the kernel selector 202, the complexity estimator 204, and the one or more selectivity kernels 106, which may work together to train the one or more selectivity kernels 106 based on the training data 402 and a loss function 410.

In some aspects, the training data 402 may include a collection of input-output pairs that can be used to train the one or more selectivity kernels 106. The input data 404 in the training data 402 may include various types of data, such as disparity maps, images, videos, depth maps, or sensor readings, depending on the specific application and the nature of the upsampling task. In some aspects, the input data 404 may be collected from real-world scenarios, such as capturing images or videos using cameras or sensors, or may be generated synthetically using computer graphics or simulation tools, or may be based on collected sensor data. The input data 404 may have different resolutions, quality levels, or noise characteristics, such as to reflect the variability and complexity of real-world data.

In some aspects, the ground truth data 406 in the training data 402 represents a desired output or target for each input sample in the input data 404. The ground truth data 406 may be manually annotated by human experts, or may be generated automatically using high-quality reference data or mathematical models. For example, in a disparity map upsampling task, the ground truth data 406 may be a high-resolution disparity map that corresponds to the low-resolution input disparity map in the input data 404. In a depth estimation task, the ground truth data 406 may be a set of accurate depth maps that correspond to the input color images or stereo pairs in the input data 404. Thus, the ground truth data 406 may serve as a reference for evaluating the quality and accuracy of the output generated by the one or more selectivity kernels 106 during the training process.

In some aspects, the kernel selector 202 and the complexity estimator 204 in the training system 400 serve similar roles as described in previous figures. For example, the kernel selector 202 may be responsible for selecting the appropriate subset of one or more selectivity kernels 106 to be applied to each input sample in the input data 404, based on the characteristics and complexity of the input sample. The complexity estimator 204 may analyze each input sample to determine its complexity and provide such information to the kernel selector 202 to guide the selection process. During the training process, the kernel selector 202 and the complexity estimator 204 may be updated or fine-tuned based on the feedback from the loss function 410, to improve their accuracy and effectiveness in selecting the appropriate one or more selectivity kernels 106 for each input sample.

In certain aspects, the one or more selectivity kernels 106 in the training system 400 may be trained using the training data 402. In some instances, each selectivity kernel 206A-206N performs a specific type of selectivity during the upsampling process, such as geometric consistency, temporal consistency, estimation confidence, feature similarity, or spatial distance. During a training process, one or more parameters and weights of each selectivity kernel 206A-206N can be adjusted based on the feedback from the loss function 410, to minimize the difference between the output generated by the one or more selectivity kernels 106 and the corresponding ground truth data 406. The training process may involve various optimization algorithms, such as stochastic gradient descent (SGD), Adam, or AdaGrad, to update the parameters and weights of the one or more selectivity kernels 106 iteratively.

In some aspects, the output 408 in the training system 400 represents the high-resolution or upsampled data generated by the one or more selectivity kernels 106 for each input sample in the input data 404. The output 408 has the same format and dimensions as the corresponding ground truth data 406, but may have different pixel values or quality levels depending on the performance of the one or more selectivity kernels 106. During the training process, the output 408 may be compared with the ground truth data 406 using the loss function 410, to measure the difference or error between the generated output and the desired output. The loss function 410 may provide a quantitative feedback signal to the one or more selectivity kernels 106, indicating how well they are performing and how they could be adjusted to improve their accuracy and quality.

In some aspects, the loss function 410 in the training system 400 may be a mathematical function that measures a difference or error between the output 408 generated by the one or more selectivity kernels 106 and the corresponding ground truth data 406. The loss function 410 may include various types of error metrics, such as mean squared error (MSE), mean absolute error (MAE), peak signal-to-noise ratio (PSNR), or structural similarity index (SSIM). In some aspects, the loss function 410 may also include regularization terms or constraints, such as sparsity or smoothness, to prevent overfitting and ensure the generalization ability of the one or more selectivity kernels 106.

In some aspects, during the training process, the loss function 410 may be evaluated for each input-output pair in the training data 402, and the results can be averaged or accumulated to obtain an overall loss value. In some examples, the overall loss value may then be used to compute the gradients or updates for the parameters and weights of the one or more selectivity kernels 106, using optimization algorithms such as SGD, Adam, or AdaGrad. The gradients may indicate the direction and magnitude of the adjustments to be made to minimize a loss value and improve the performance of the one or more selectivity kernels 106. The training process can be repeated iteratively, with each iteration using a different subset or batch of the training data 402, until the loss value converges or reaches a satisfactory level.

In some aspects, training the ML model comprises associating each of the selectivity kernels with a corresponding loss term. For example, a first selectivity kernel may be associated with a first loss term corresponding to a first type of selectivity, such as geometric consistency, while a second selectivity kernel may be associated with a second loss term corresponding to a second type of selectivity, such as feature similarity. The first and second selectivity kernels are then trained using their respective first and second loss terms, which measure the error between the predicted and ground truth outputs for each type of selectivity. This allows the selectivity kernels to specialize in different aspects of the disparity upsampling based disparity estimation process and collectively contribute to the final output.

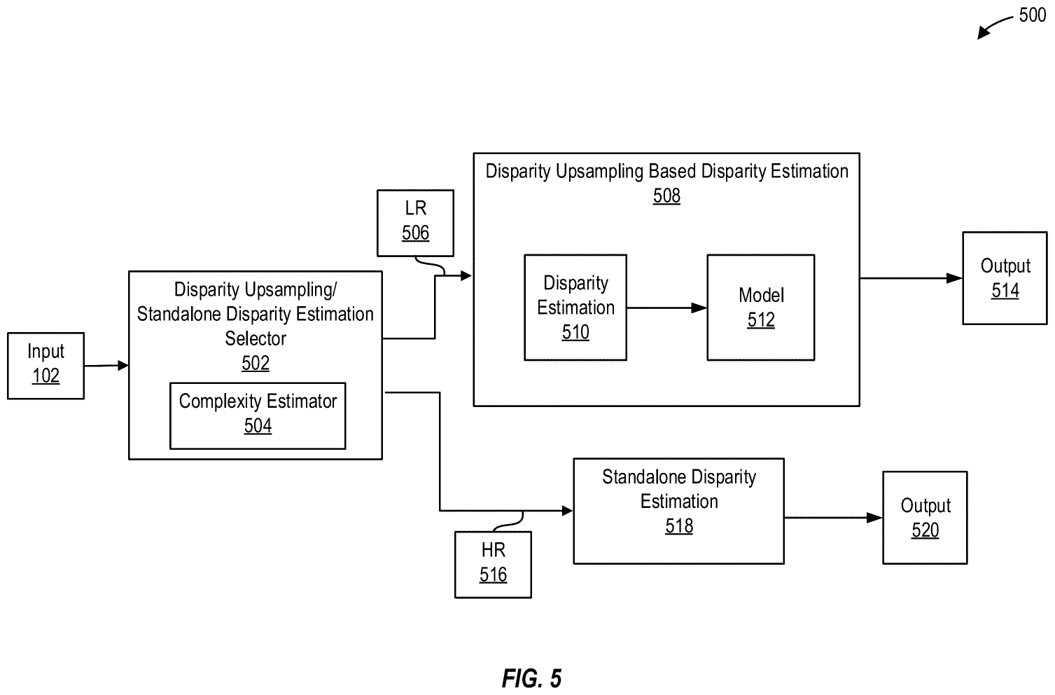

FIG. 5 depicts a system 500 for performing disparity estimation according to aspects of the present disclosure. In some aspects, the system 500 may include an input data 102, a disparity upsampling/standalone disparity estimation selector 502, a complexity estimator 504, a disparity upsampling based disparity estimation module 508, and a standalone disparity estimation module 518. In some aspects, the input data 102 represents a high resolution image or data that is to undergo disparity estimation. In some examples, this input data 102 may be captured by a camera or sensor, or it may be generated by a computer or other imaging device. In some aspects, the disparity upsampling/standalone disparity estimation selector 502 may determine whether to perform standalone disparity estimation or disparity upsampling based disparity estimation based on the input data 102. In some aspects, such a determination may be based on the complexity of the scene, which may be assessed by the complexity estimator 504. In certain aspects, the complexity estimator 504 may analyze various aspects of the input data 102, such as the number of objects, the level of detail, the presence of occlusions, and other factors that contribute to the intricacy and/or complexity of the scene. In examples, the complexity estimator 504 can provide such estimation to the disparity upsampling/standalone disparity estimation selector 502, which may enable the disparity upsampling/standalone disparity estimation selector 502 to make an informed decision on a most appropriate disparity estimation technique to employ.

For example, if the disparity upsampling/standalone disparity estimation selector 502 determines that disparity upsampling based disparity estimation is to be performed, low resolution image/data 506 can be utilized, where the low resolution image/data 506 may correspond to a subsampled version of the input data 102. That is, in certain aspects, the low resolution image/data 506 represents a downscaled, or downsampled, version of the input data 102, having a lower resolution than the input data 102 and/or the high resolution image/data 516, where the high resolution image/data 516 may be based on the input data 102. In certain aspects, the downscaling process may be performed by a separate module or incorporated into the disparity upsampling based disparity estimation module 508. In some aspects, the low resolution image/data 506 is provided to the disparity upsampling based disparity estimation module 508, which performs disparity estimation 510 on the low resolution data using techniques such as those described with reference to FIG. 1. The resulting low resolution disparity map may then be upsampled using the model 512 to obtain a higher resolution disparity map as the output 514. In some aspects, the model 512 may be a machine learning model, such as a convolutional neural network, that has been trained to perform disparity upsampling. For example, the model 512 may take the low resolution disparity map as input and generate a corresponding high resolution disparity map by learning and applying one or more upsampling patterns and techniques. In certain aspects, the model 512 may be an ML model comprising a plurality of selectivity kernels, such as described herein, such as ML model 104 of FIGS. 1 and 2.

In some aspects, if the disparity upsampling/standalone disparity estimation selector 502 determines that standalone disparity estimation is to be performed, high resolution image/data 516 may be provided to the standalone disparity estimation module 518. In examples, the standalone disparity estimation module 518 performs disparity estimation on the high resolution image/data 516 utilizing on or more algorithms, such as block matching, feature matching, or optimization-based methods, to estimate a disparity map from the high resolution input. The resulting disparity map is provided as the output 520.

In certain aspects, the outputs 514 and 520 represent the high resolution disparity maps generated by the disparity upsampling based disparity estimation module 508 and the standalone disparity estimation module 518, respectively. These outputs may include information about the disparity between corresponding points in the left and right images of a stereo pair, which can be used for various applications that require high resolution disparity information, such as 3D reconstruction, object detection, autonomous navigation, or virtual reality.

In some aspects, the model 512 may perform disparity upsampling based disparity estimation utilizing one or more techniques described with respect to FIGS. 1-4. For example, one or more selectivity kernels may be employed by the model 512 to perform disparity upsampling based disparity estimation. In some aspects, while depicted separately, disparity estimation 510 and standalone disparity estimation module 518 may be a single module capable of performing standalone disparity estimation on both low resolution images/data and high resolution images/data.

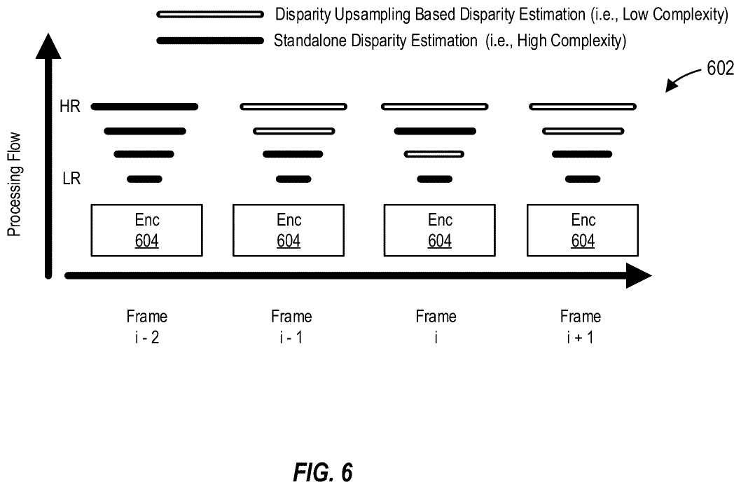

FIG. 6 depicts an example of adaptively selecting between standalone disparity estimation and disparity upsampling based disparity estimation for an input disparity map, in accordance with aspects of the present disclosure. In some aspects, an encoder 604 may process one or more disparity maps 602 at different time steps. In some aspects, one or more of the systems 500 (FIG. 5) for performing disparity estimation (e.g., disparity upsampling based disparity estimation or standalone disparity estimation) may provide a disparity map according to aspects of the present disclosure.

In some aspects, the disparity maps 602 represent a sequence of disparity information captured or generated at different time steps. For example, one or more of each disparity map 602 may capture a pixel-wise correspondence between a pair of stereo images at a specific moment or scene. The disparity maps 602 may have different resolutions, formats, or characteristics, depending on the specific requirements of the application. For example, the disparity maps 602 may be in a low-resolution format, and a goal may be to convert the lower resolution disparity maps into a high-resolution format for use by other downstream tasks.

In some aspects, the encoder 604 processes the disparity maps 602 to reduce their size and redundancy, and to extract relevant features and information for the disparity upsampling process. The encoder 604 may use various encoding techniques, such as transform coding or quantization, to compress the disparity maps 602 and remove spatial and temporal redundancies. In some aspects, the encoded disparity maps are provided to the disparity upsampling based disparity estimation module 508 (FIG. 5) and/or the standalone disparity estimation module 518 (FIG. 5). In certain aspects, the disparity upsampling based disparity estimation module 508 (FIG. 5) may apply upsampling techniques to upsample the encoded disparity maps in both spatial and temporal dimensions. In some aspects, an upsampling process may be performed using a pyramid structure, where the disparity maps may be processed at multiple resolution levels, from low to high resolution. As an example, one or more types of selectivity and/or one or more types of selectivity kernels may be employed by the model 512 to perform disparity upsampling based disparity estimation at one or more pyramid levels of the pyramid structure. As another example, in some aspects different types of selectivity and/or different types of selectivity kernels may be applied at different pyramid levels, where in some aspects, a selectivity kernel applied to a pyramid level may depend on a complexity associated with the pyramid level. As depicted in FIG. 6, the X-axis represents the frame index, ranging from frame i−2 to frame i+1, while the Y-axis represents the processing flow, starting from the low-resolution pyramid level and progressing towards the high-resolution pyramid level.

In some aspects, at each pyramid level, the disparity upsampling/standalone disparity estimation selector 502 may adaptively determine whether to perform standalone disparity estimation or disparity upsampling based disparity estimation based on the complexity and characteristics of the disparity information. Standalone disparity estimation may be a computationally expensive process that calculates the pixel-wise correspondence between consecutive frames directly at the high resolution, while disparity upsampling based disparity estimation may be a more efficient process that interpolates the disparity values from a lower resolution to a higher resolution.

In examples, an adaptive and content-aware approach to disparity estimation is employed such that a disparity estimation technique can be applied at different pyramid levels. For example, if the pixel-wise or object-wise movement between consecutive disparity maps is relatively small at a certain pyramid level, a system 500 (FIG. 5) may adaptively determine to perform disparity upsampling instead of standalone disparity estimation. This is because the disparity upsampling process can potentially achieve a similar level of quality as standalone disparity estimation with minimal motion, while being more computationally efficient.

In some examples, the determination to switch between standalone disparity estimation and disparity upsampling may be made adaptively for each pyramid level and each disparity map, based on the content and complexity of the disparity information. The adaptive selection allows the system (e.g., system 500 of FIG. 5) to allocate computational resources more efficiently and improve the overall performance of the disparity estimation process.

### Example Artificial Intelligence System for Multi-Factor Selectivity Kernels in a Model

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

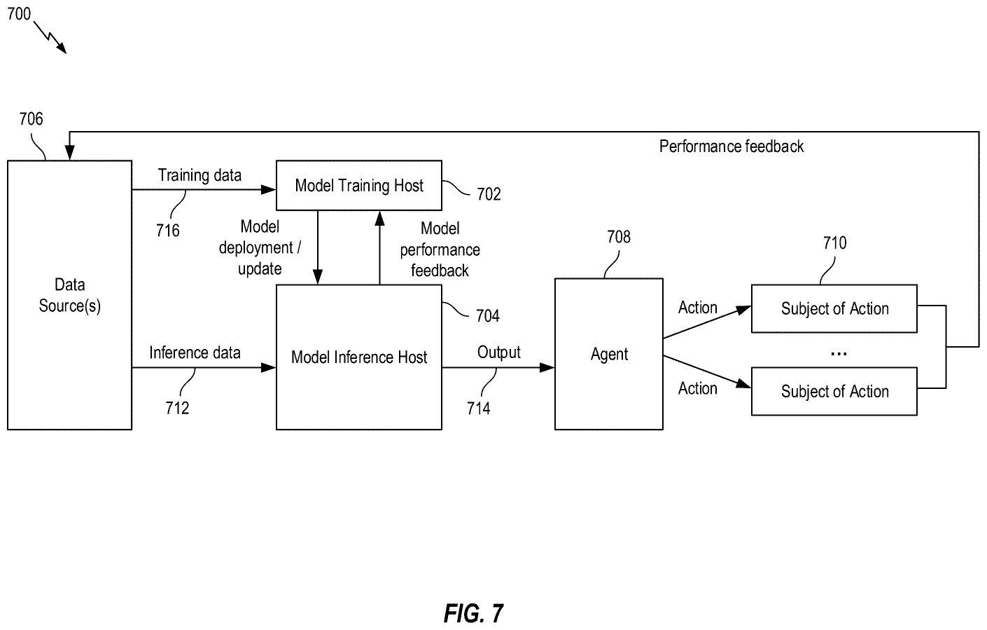

FIG. 7 is a diagram illustrating an example AI architecture 700 that may be used to implement the machine learning models and multi-factor selectivity kernel techniques described in this disclosure. As illustrated, the architecture 700 includes multiple logical entities, such as a model training host 702 for training the machine learning model with multi-factor selectivity kernels, a model inference host 704 for running inference using the trained model, data source(s) 706 providing training and inference data, and an agent 708 that utilizes the model's output. This AI architecture could be used to enable the example disclosed multi-factor selectivity kernel techniques in various machine learning applications.

The model inference host 704, in the architecture 700, is configured to run an ML model based on inference data 712 provided by data source(s) 706. The model inference host 704 may produce an output 714 (e.g., a prediction or inference, such as a discrete or continuous value) based on the inference data 712, that is then provided as input to the agent 708.

The agent 708 may be an element or entity that utilizes the output of the machine learning model hosted by the model inference host 704. The agent 708 could be a software component, a hardware accelerator, or a system that leverages the upsampled estimates produced by the model for various downstream tasks such as image processing, depth estimation, or other regression and estimation problems.

For example, if the output 714 from the model inference host 704 is an upsampled disparity map obtained through multi-factor selectivity kernels, the agent 708 may be an augmented reality application that uses the disparity map for rendering virtual objects. As another example, if the output 714 is an enhanced image produced by a model trained with multi-factor selectivity kernels, the agent 708 could be an image editing software.

After receiving the output 714 from the model inference host 704, the agent 708 may determine how to utilize it. For instance, if the agent 708 is an augmented reality app and the output is a disparity map, it may use the disparity information to occlude virtual objects behind real ones or to place virtual objects on real surfaces in a plausible manner. If the agent 708 decides to use the output 714, it may apply it to the subject of the action 710, which represents the data being processed or enhanced. In the augmented reality example, the subject of action 710 would be the rendered scene. In some cases, the agent 708 and subject of action 710 may be tightly integrated.

The data sources 706 may be configured to collect data used as training data 716 for the model training host 702 to train the multi-factor selectivity kernel-based machine learning models. The data sources 706 may also provide inference data 712 to the model inference host 704. This data could come from various entities and may include the subject of action 710. For example, for training a depth estimation model, the data sources 706 may collect stereo images and corresponding ground truth depth maps. The model training host 702 can then monitor the model's performance on this data to determine if retraining or fine-tuning with the multi-factor selectivity kernel techniques is necessary to improve accuracy. In some cases, the agent 708 and the subject of action 710 are the same entity.

The data sources 706 may be configured for collecting data that is used as training data 716 for training the machine learning model with multi-factor selectivity kernels. The data sources 706 may also provide inference data 712 (also referred to as input data) for feeding the trained model during inference. In particular, the data sources 706 may collect data relevant to the upsampling task at hand, such as low-resolution disparity maps, images, or video frames. This data may come from various sources, including the subject of action 710, which represents the data being processed by the model. The collected data is provided to the model training host 702 for training and fine-tuning the multi-factor selectivity kernel-based model. For example, after the inference data (e.g., low resolution disparity map) is processed by the model, the output 714 (e.g., an upsampled high-resolution disparity map) may be compared to ground truth data to evaluate the model's performance. If the output 714 is not sufficiently accurate, this performance feedback may be used by the model training host 702 to further train the model using the disclosed multi-factor selectivity kernel techniques, aiming to improve its upsampling accuracy. The updated model may then be deployed to the model inference host 704.

In certain aspects, the model training host 702 may be deployed at or with the same or a different entity than that in which the model inference host 704 is deployed. For example, in order to offload model training processing, which can impact the performance of the model inference host 704, the model training host 702 may be deployed at a model server as further described herein. Further, in some cases, training and/or inference may be distributed amongst devices in a decentralized or federated fashion.

In some aspects, a machine learning model utilizing multi-factor selectivity kernels is deployed at or on a computing device for enhancing the performance of upsampling tasks. More specifically, a model inference host, such as model inference host 704 in FIG. 7, may be deployed at or on the computing device for running the multi-factor selectivity kernel-based model to upsample low-resolution features and improve accuracy.

In some other aspects, the multi-factor selectivity kernel-based machine learning model is deployed at or on an embedded system or mobile device for enabling efficient on-device inference. More specifically, a model inference host, such as model inference host 704 in FIG. 7, may be deployed at or on the embedded system or mobile device for running the model to obtain high-quality upsampled features while meeting resource constraints.

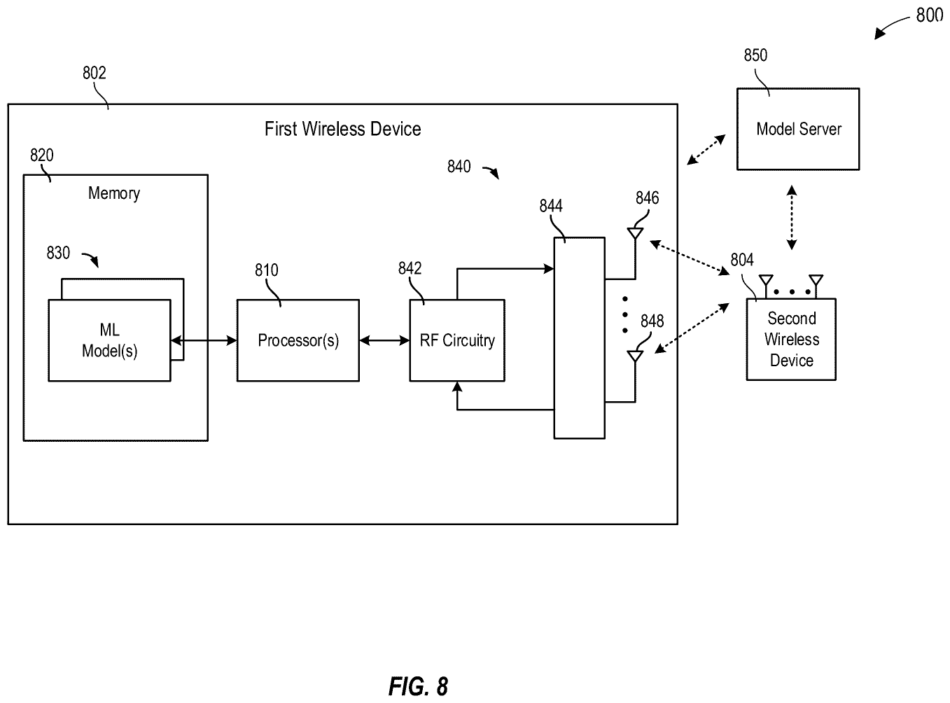

FIG. 8 illustrates an example AI architecture 800 of a first computing device 802 that is in communication with a second computing device 804. The first computing device 802 may be a server or cloud computing platform as described herein with respect to FIG. 7. Similarly, the second computing device 804 may be an embedded system or mobile device as described herein with respect to FIG. 7. Note that the AI architecture of the first computing device 802 may be applied to the second computing device 804.

The first computing device 802 may be, or may include, a chip, system on chip (SoC), a system in package (SiP), chipset, package or device that includes one or more processors, processing blocks or processing elements (collectively “the processor 810”) and one or more memory blocks or elements (collectively “the memory 820”).

As an example, in a model inference mode, the processor 810 may transform input data (e.g., low-resolution images, sensor readings) into a format suitable for the multi-factor selectivity kernel-based model. The processor 810 may then run the model on the formatted input data to generate an upsampled output. The processor 810 may be coupled to a transceiver 840 for transmitting the upsampled output to and/or receiving input data from one or more connected devices 846. The transceiver 840 includes interface circuitry 842 and 844 for converting between the digital signals of the processor and any transmission protocol used by the connected devices 846 and/or 848. The connected devices 846 may be sensors, actuators, displays, or storage that provide input to or consume the output from the model.

When receiving input data via the connected devices 846 (e.g., from the second computing device 804), the transceiver interface circuitry 842 and 844 may convert the received signals to a baseband frequency and then to digital signals for processing by the processor 810. The processor 810 may format the digital input signals and feed them into the multi-factor selectivity kernel-based model for inference.

One or more ML models 830 may be stored in the memory 820 and accessible to the processor(s) 810. In certain cases, different ML models 830 with different characteristics may be stored in the memory 820, and a particular ML model 830 may be selected based on its characteristics and/or application as well as characteristics and/or conditions of first wireless device 802 (e.g., a power state, a mobility state, a battery reserve, a temperature, etc.). For example, the ML models 830 may have different inference data and output pairings (e.g., different types of inference data produce different types of output), different levels of accuracies (e.g., 80%, 90%, or 95% accurate) associated with the predictions (e.g., the output 714 of FIG. 7), different latencies (e.g., processing times of less than 10 ms, 100 ms, or 1 second) associated with producing the predictions, different ML model sizes (e.g., file sizes), different coefficients or weights, etc.

The processor 810 may use the ML model 830 to produce output data (e.g., the output 714 of FIG. 7) based on input data (e.g., the inference data 712 of FIG. 7), for example, as described herein with respect to the inference host 704 of FIG. 7. The ML model 830 may be used to perform any of various AI-enhanced tasks, such as those listed above.

As an example, the ML model 830 may take a low-resolution input as input to predict an upsampled output using one or more example multi-factor selectivity kernel techniques previously described. The input data may include, for example, low-resolution disparity map, images, video frames, or depth maps. The output data may include, for example, a high-resolution version of the input data, which is obtained by applying the multi-factor selectivity kernels within the model. In certain aspects, the upsampled output may be considered a “virtual” result in that it is not directly measured but rather inferred by the model based on the low-resolution input and the learned selectivity criteria. In other cases, the upsampled output may correspond to a physical quantity that is measurable in principle but not directly observed by the sensors available to the system. Note that other input data and/or output data may be used in addition to or instead of the examples described herein, depending on the specific upsampling task and the available sensors.

In certain aspects, a model server 850 may perform any of various ML model lifecycle management (LCM) tasks for the first wireless device 802 and/or the second computing device 804. The model server 850 may operate as the model training host 702 and update the ML model 830 using training data. In some cases, the model server 850 may operate as the data source 706 to collect and host training data, inference data, and/or performance feedback associated with an ML model 830. In certain aspects, the model server 850 may host various types and/or versions of the ML models 830 for the first wireless device 802 and/or the second computing device 804 to download.

In some cases, the model server 850 may monitor and evaluate the performance of the ML model 830 that utilizes multi-factor selectivity kernels to trigger one or more LCM tasks. For example, the model server 850 may determine whether to activate or deactivate the use of a particular multi-factor selectivity kernel-based model at the first computing device 802 and/or the second computing device 804, based on factors such as the accuracy requirements, computational budget, and energy constraints of each device. The model server 850 may then provide instructions to the respective devices to manage their model usage accordingly. In some cases, the model server 850 may determine whether to switch to a different variant of the multi-factor selectivity kernel-based ML model 830 at the first computing device 802 and/or the second computing device 804, based on changes in the operating conditions or performance objectives. For instance, the model server may instruct a device to switch from a complex model with high accuracy to a simpler model with lower latency when the battery level falls below a threshold. In yet further examples, the model server 850 may act as a central coordinator for collaborative learning of multi-factor selectivity kernel-based models across multiple devices, using techniques such as federated learning to train a global model from locally-computed updates while preserving data privacy.

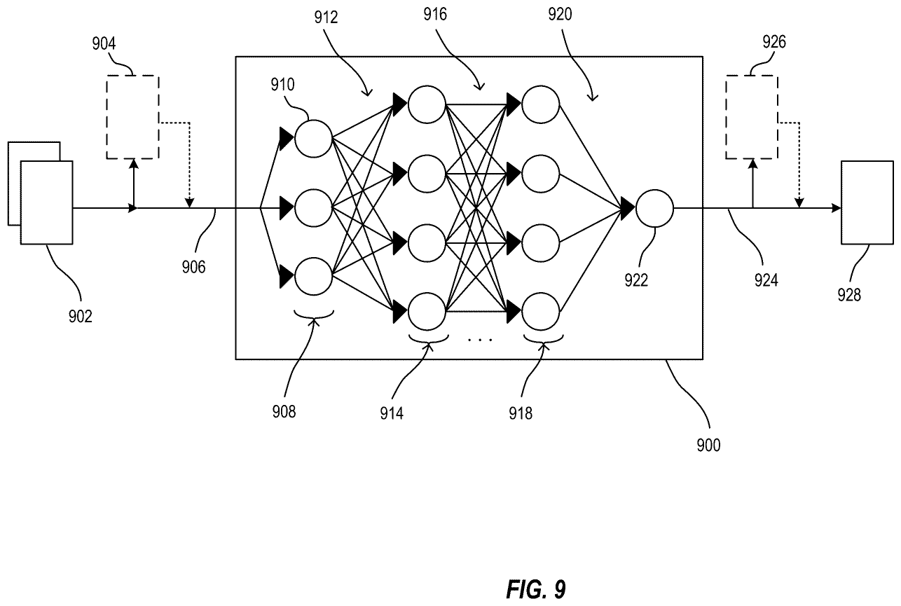

FIG. 9 is an illustrative block diagram of an example artificial neural network (ANN) 900.

ANN 900 may receive input data 906 which may include one or more bits of data 902, pre-processed data output from pre-processor 904 (optional), or some combination thereof. Here, data 902 may include training data, verification data, application-related data, or the like, e.g., depending on the stage of development and/or deployment of ANN 900. Pre-processor 904 may be included within ANN 900 in some other implementations. Pre-processor 904 may, for example, process all or a portion of data 902 which may result in some of data 902 being changed, replaced, deleted, etc. In some implementations, pre-processor 904 may add additional data to data 902.

ANN 900 includes at least one first layer 908 of artificial neurons 910 (e.g., perceptrons) to process input data 906 and provide resulting first layer output data via edges 912 to at least a portion of at least one second layer 914. Second layer 914 processes data received via edges 912 and provides second layer output data via edges 916 to at least a portion of at least one third layer 918. Third layer 918 processes data received via edges 916 and provides third layer output data via edges 920 to at least a portion of a final layer 922 including one or more neurons to provide output data 924. All or part of output data 924 may be further processed in some manner by (optional) post-processor 926. Thus, in certain examples, ANN 900 may provide output data 928 that is based on output data 924, post-processed data output from post-processor 926, or some combination thereof. Post-processor 926 may be included within ANN 900 in some other implementations. Post-processor 926 may, for example, process all or a portion of output data 924 which may result in output data 928 being different, at least in part, to output data 924, e.g., as result of data being changed, replaced, deleted, etc. In some implementations, post-processor 926 may be configured to add additional data to output data 924. In this example, second layer 914 and third layer 918 represent intermediate or hidden layers that may be arranged in a hierarchical or other like structure. Although not explicitly shown, there may be one or more further intermediate layers between the second layer 914 and the third layer 918.

The structure and training of artificial neurons 910 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 712 in FIG. 7). Some non-exhaustive example activation functions include a linear function, binary step function, sigmoid, hyperbolic tangent (tan h), a rectified linear unit (ReLU) and variants, exponential linear unit (ELU), Swish, Softmax, and others.

Design tools (such as computer applications, programs, etc.) may be used to select appropriate structures for ANN 900 and a number of layers and a number of artificial neurons in each layer, as well as selecting activation functions, a loss function, training processes, etc. Once an initial model has been designed, training of the model may be conducted using training data. Training data may include one or more datasets within which ANN 900 may detect, determine, identify or ascertain patterns. Training data may represent various types of information, including written, visual, audio, environmental context, operational properties, etc. During training, parameters of artificial neurons 910 may be changed, such as to minimize or otherwise reduce a loss function or a cost function. A training process may be repeated multiple times to fine-tune ANN 900 with each iteration.

Various ANN model structures are available for consideration. For example, in a feedforward ANN structure each artificial neuron 910 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 900 or other ML models may be implemented in various types of processing circuits along with memory and applicable instructions therein, for example, as described herein with respect to FIGS. 7 and 8. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 900 of FIG. 9.

As part of the development process for machine learning models that utilize multi-factor selectivity kernels, relevant training data must be gathered or generated. For example, training data may include ground truth labels for the desired output quantities (e.g., high-resolution images, depth maps, segmentation masks), as well as corresponding low-resolution input observations (e.g., low-resolution images, depth maps, segmentation masks). This data can be used to train the model to accurately upsample low-resolution features using the selectivity kernels for the given task. In certain instances, the training data may originate from sensors on user devices (e.g., smartphones, robots, vehicles), dedicated data collection equipment (e.g., multi-camera rigs, depth sensors), or public datasets. In some cases, the training data may be aggregated from multiple sources to cover a wide range of scenarios and improve model generalization. For example, crowdsourcing platforms or online databases may be leveraged to gather diverse examples for training multi-factor selectivity kernel-based models. In another example, training data may be generated synthetically using simulation engines or generative models to augment real-world samples. The training data collection process can be performed offline, resulting in a static dataset for batch training, or online, where new samples are continuously incorporated into the model training pipeline. For example, an embedded system may periodically upload new training samples gathered during operation to a server, which then fine-tunes the multi-factor selectivity kernel-based model using online learning techniques. For offline training, data collection and model updates can occur at a central location (e.g., a datacenter) or be distributed across multiple nodes (e.g., a sensor network). For online training, the model may be adapted locally on each device or by a remote server that receives streaming data from the devices.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 900 of FIG. 9, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that utilize multi-factor selectivity kernels on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of upsampling tasks such as image super-resolution or depth map refinement, for example, federated learning may be used to improve model performance by allowing it to learn from a wide range of environments and conditions. For instance, a multi-factor selectivity kernel-based image upsampling model may be trained on data collected from a large number of smartphones or cameras, each with its own image quality and content, to improve its robustness and generalization. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the multi-factor selectivity kernel-based model achieves satisfactory performance across all participating devices. By enabling collaborative learning while keeping data localized, federated learning allows the development of powerful upsampling models that can leverage diverse datasets without compromising privacy or security.

In some implementations, one or more devices or services may support processes relating to the usage, maintenance, activation, and reporting of machine learning models that utilize damping propagation and probabilistic initialization. In certain instances, all or part of the training data or the trained model may be shared across multiple devices to provide or improve the estimation capabilities. For example, a smartphone with a depth sensor may share its data with a smartphone having only a single camera, enabling the latter to train a depth estimation model using propagation guidance. In some cases, signaling mechanisms may be employed to communicate the capabilities and requirements for performing specific functions related to propagation-enhanced models, such as the supported input and output formats, the available computational resources, or the ability to collect and share training data. These models may be used to support various applications, such as augmented reality, robotics, autonomous driving, or video processing, where accurate and efficient estimation of quantities like depth, flow, or segmentation is important. The deployment of propagation-guided models may occur at different levels of a system architecture, such as on individual devices (e.g., smartphones, vehicles), edge servers (e.g., base stations, access points), or cloud platforms, depending on factors such as latency requirements, data privacy concerns, and resource availability. By leveraging the disclosed propagation techniques, these models can provide high-quality estimates while operating under the constraints of each deployment scenario.

### Example Operations for Performing Upsampling

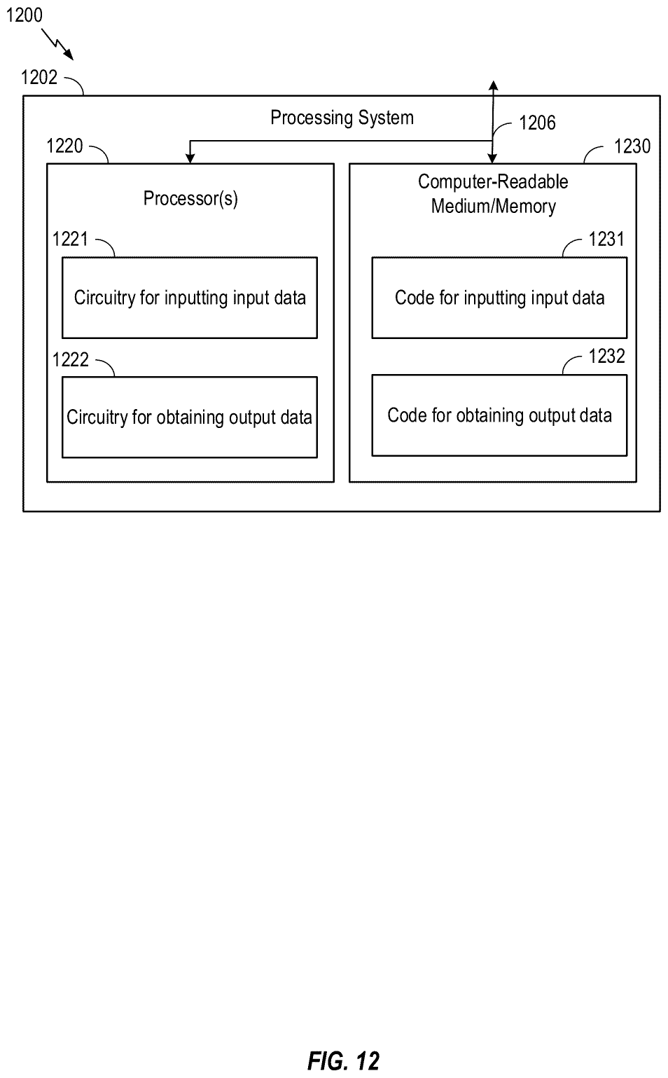

In one aspect, method 1000, or any aspect related to it, may be performed by an apparatus, such as processing system 1200 of FIG. 12, which includes various components operable, configured, or adapted to perform the method 1000.

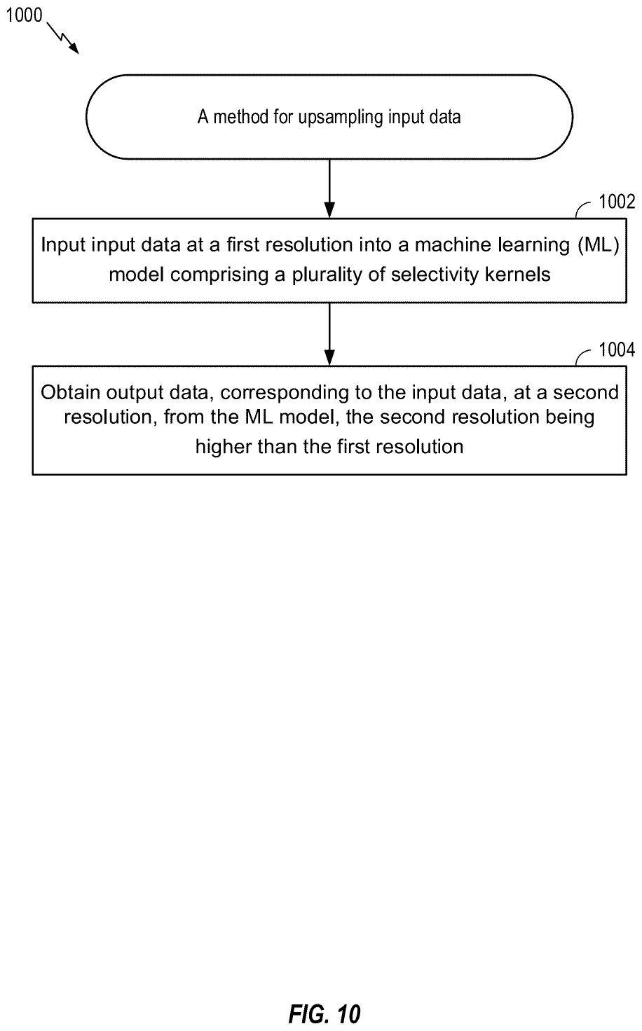

Note that FIG. 10 is just one example of a method, and other methods including fewer, additional, or alternative steps are possible consistent with this disclosure.

Method 1000 starts at 1002 with inputting input data at a first resolution into an ML model comprising a plurality of selectivity kernels. In some aspects of method 1000, each of the plurality of selectivity kernels is configured to perform a different type of selectivity to upsample the input data.

Method 1000 then ends at 1004 with obtaining output data, corresponding to the input data, at a second resolution, from the ML model, the second resolution being higher than the first resolution. In some aspects of method 1000, the output data is based on a composite of outputs from the plurality of selectivity kernels.

In some aspects of method 1000, the input data comprises data for a plurality of modalities, and wherein each kernel of the selectivity kernels is configured to take as input, input data corresponding to a different modality of the plurality of modalities.

In some aspects of method 1000, the plurality of modalities comprises two or more of: RGB data, LIDAR data, audio data, event camera data, RF data, Ultrasonic data, or Infra-red data.

In some aspects of method 1000, a first selectivity kernel of the plurality of selectivity kernels is configured to perform a first type of selectivity comprising geometric consistency selectivity, temporal consistency selectivity, or estimation confidence selectivity.

In some aspects of method 1000, a second selectivity kernel of the plurality of selectivity kernels is configured to perform a second type of selectivity comprising feature similarity selectivity or spatial distance selectivity.

In some aspects of method 1000, the input data comprises three-dimensional (3D) data, and wherein at least one of the plurality of selectivity kernels is a 3D spatial selectivity kernel.

In some aspects of method 1000, the ML model is trained using a loss function that imposes multiple loss terms, wherein each loss term of the multiple loss terms corresponds to a different one of the plurality of selectivity kernels.

In some aspects, method 1000 includes associating a first selectivity kernel to a first loss term corresponding to a first type of selectivity; associating a second selectivity kernel to a second loss term corresponding to a second type of selectivity; and training the first and second selectivity kernels using the first and second loss terms.

In some aspects, method 1000 includes selecting the plurality of selectivity kernels based on content of the input data.

In some aspects of method 1000, selecting the plurality of selectivity kernels based on content of the input data comprises: analyzing the content of the input data; determining a complexity of the content; and selecting the plurality of selectivity kernels based on the determined complexity.

In some aspects of method 1000, the input data comprises a plurality of frames, and method 1000 includes determining a complexity of each frame of the plurality of frames; and applying different selectivity kernels to different frames based on the determined complexity of each frame.

In some aspects of method 1000, to determine the complexity of each frame of the plurality of frames comprises one or more of: analyzing one or more of spatial details, edges, or textures within the frame; analyzing one or more of temporal details, motion, or changes between consecutive frames; analyzing one or more objects within the frame; analyzing an overall scene composition or content of the frame; or using a machine learning model trained to estimate frame complexity based on one or more extracted features of the frame.

In some aspects of method 1000, the input data comprises data at a plurality of pyramid levels, and wherein different selectivity kernels are applied at different pyramid levels.

In some aspects of method 1000, the different selectivity kernels are applied at different pyramid levels based on a complexity of each pyramid level.

In some aspects of method 1000, the input data comprises at least one of a disparity map, a depth map, a segmentation map, or an optical flow map.

In some aspects, method 1000 includes receiving the input data via a modem coupled to one or more antennas and one or more processors.

In some aspects of method 1000, the modem the one or more antennas are integrated into at least one of a vehicle, an extra-reality device, or a mobile device.

### Example Operations for Performing Upsampling

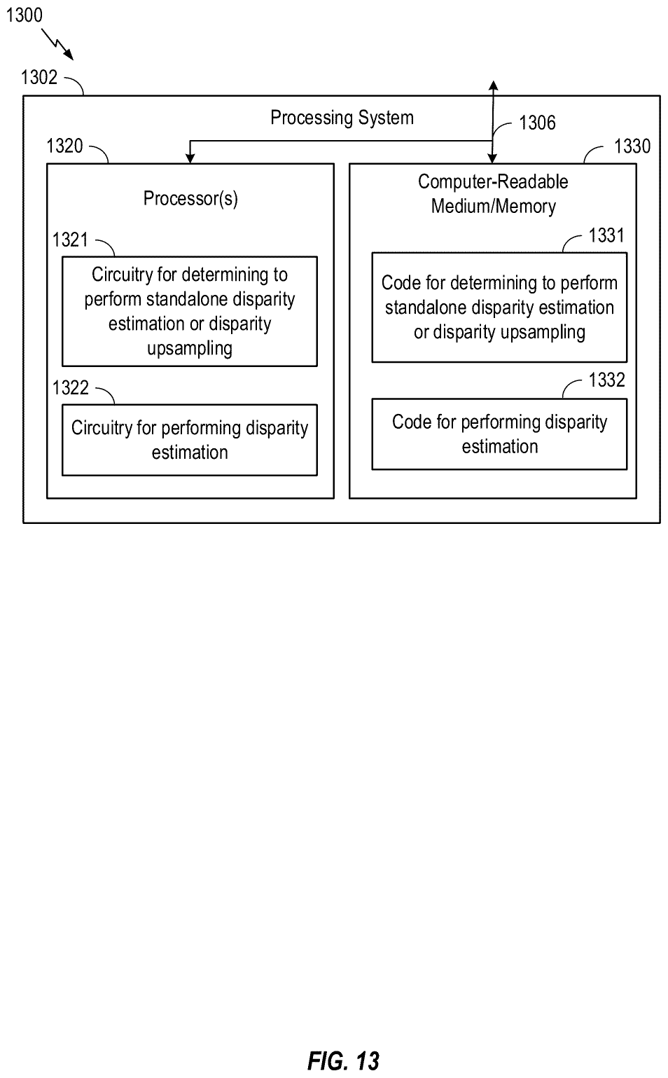

In one aspect, method 1100, or any aspect related to it, may be performed by an apparatus, such as processing system 1300 of FIG. 13, which includes various components operable, configured, or adapted to perform the method 1100.

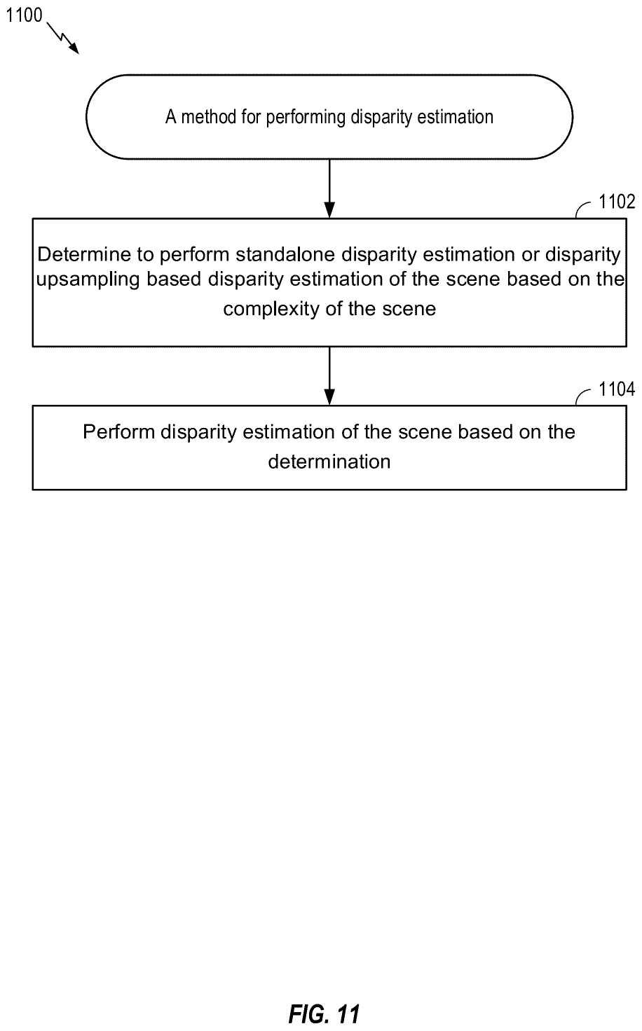

Note that FIG. 11 is just one example of a method, and other methods including fewer, additional, or alternative steps are possible consistent with this disclosure.

Method 1100 starts at 1102 with determining to perform standalone disparity estimation or disparity upsampling based disparity estimation of the scene based on the complexity of the scene.

Method 1100 then ends at 1104 with performing disparity estimation of the scene based on the determination.

In some aspects of method 1100, determining to perform standalone disparity estimation or disparity upsampling based disparity estimation comprises: comparing the complexity of the scene to a threshold; if the complexity satisfies the threshold, determining to perform standalone disparity estimation; and if the complexity does not satisfy the threshold, determining to perform disparity upsampling based disparity estimation.

In some aspects of method 1100, the complexity of the scene is based on one or more of: a number of objects in the scene, a level of motion in the scene, or a level of lighting in the scene.

In some aspects of method 1100, performing the disparity estimation comprises performing disparity upsampling based disparity estimation using a machine learning model comprising a plurality of selectivity kernels, wherein each selectivity kernel is configured to perform a different type of selectivity for upsampling.

In some aspects of method 1100, a first selectivity kernel of the plurality of selectivity kernels is configured to perform geometric consistency selectivity based on a geometric consistency kernel, and a second selectivity kernel of the plurality of selectivity kernels is configured to perform temporal consistency selectivity based on a spatiotemporal selectivity kernel.

In some aspects of method 1100, a third selectivity kernel of the plurality of selectivity kernels is configured to perform estimation confidence selectivity based on an estimation confidence kernel.

In some aspects of method 1100, performing disparity estimation of the scene based on the determination comprises obtaining output data, corresponding to input data of the scene, from a machine-learning model, where the output data is based on a composite of outputs from the plurality of selectivity kernels.

In some aspects of method 1100, the plurality of selectivity kernels are configured to perform selectivity based on at least one of feature similarity, spatial distance, geometric consistency, temporal consistency, or estimation confidence.

In some aspects, method 1100 includes receiving second information indicating complexity of a second scene; determining to perform standalone disparity estimation or disparity upsampling based disparity estimation of the second scene based on the complexity of the second scene; and performing disparity estimation of the second scene based on the determination for the second scene.

In some aspects of method 1100, standalone disparity estimation is performed for a first scene and disparity upsampling based disparity estimation is performed for a second scene.

In some aspects of method 110, determining to perform standalone disparity estimation or disparity upsampling based disparity estimation is further based on at least one of a level of accuracy or a computational efficiency.

In some aspects, method 1100 includes receiving the information indicating complexity of the scene via a modem coupled to one or more antennas and one or more processors.

In some aspects of method 1100, the modem the one or more antennas are integrated into at least one of a vehicle, an extra-reality device, or a mobile device.

### Example Processing System for Performing Upsampling

FIG. 12 depicts aspects of an example processing system 1200.

The processing system 1200 includes a processing system 1202 includes one or more processors 1220. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1000 described with respect to FIG. 10, or any aspect related to it, including any additional steps or sub-steps described in relation to FIG. 10.

In the depicted example, computer-readable medium/memory 1230 stores code (e.g., executable instructions) for inputting input data 1231 and code for obtaining output data 1232. Processing of the code 1231-1232 may enable and cause the processing system 1200 to perform the method 1000 described with respect to FIG. 10, or any aspect related to it.

The one or more processors 1220 include circuitry configured to implement (e.g., execute) the code stored in the computer-readable medium/memory 1230, including circuitry for inputting input data 1221 and circuitry for obtaining output data 1222. Processing with circuitry 1221-1222 may enable and cause the processing system 1200 to perform the method 1000 described with respect to FIG. 10, or any aspect related to it.

### Example Processing System for Determining a Disparity Estimation Process

FIG. 13 depicts aspects of an example processing system 1300.

The processing system 1300 includes a processing system 1302 includes one or more processors 1320. The one or more processors 1320 are coupled to a computer-readable medium/memory 1330 via a bus 1306. In certain aspects, the computer-readable medium/memory 1330 is configured to store instructions (e.g., computer-executable code) that when executed by the one or more processors 1320, cause the one or more processors 1320 to perform the method 1100 described with respect to FIG. 11, or any aspect related to it, including any additional steps or sub-steps described in relation to FIG. 11.

In the depicted example, computer-readable medium/memory 1330 stores code (e.g., executable instructions) for determining to perform standalone disparity estimation or disparity upsampling based disparity estimation 1331 and code for performing disparity estimation 1332. Processing of the code 1331-1332 may enable and cause the processing system 1300 to perform the method 1100 described with respect to FIG. 11, or any aspect related to it.

The one or more processors 1320 include circuitry configured to implement (e.g., execute) the code stored in the computer-readable medium/memory 1330, including circuitry for determining to perform disparity upsampling based disparity estimation 1321 and circuitry for performing disparity estimation 1322. Processing with circuitry 1321-1322 may enable and cause the processing system 1300 to perform the method 1100 described with respect to FIG. 11, or any aspect related to it.

### Example Clauses

Implementation examples are described in the following numbered clauses:
Clause 1: A method for upsampling input data, comprising: inputting input data at a first resolution into a machine learning (ML) model comprising a plurality of selectivity kernels, each of the plurality of selectivity kernels configured to perform a different type of selectivity to upsample the input data; and obtaining output data, corresponding to the input data, at a second resolution, from the ML model, the second resolution being higher than the first resolution, wherein the output data is based on a composite of outputs from the plurality of selectivity kernels.
Clause 2: A method in accordance with Clause 1, wherein the input data comprises data for a plurality of modalities, and wherein each kernel of the selectivity kernels is configured to take as input, input data corresponding to a different modality of the plurality of modalities.
Clause 3: A method in accordance with Clause 2, wherein the plurality of modalities comprises two or more of: RGB data, LIDAR data, audio data, event camera data, RF data, Ultrasonic data, or Infra-red data.
Clause 4: A method in accordance with any one of Clauses 1-3, wherein a first selectivity kernel of the plurality of selectivity kernels is configured to perform a first type of selectivity comprising geometric consistency selectivity, temporal consistency selectivity, or estimation confidence selectivity.
Clause 5: A method in accordance with Clause 4, wherein a second selectivity kernel of the plurality of selectivity kernels is configured to perform a second type of selectivity comprising feature similarity selectivity or spatial distance selectivity.
Clause 6: A method in accordance with any one of Clauses 1-5, wherein the input data comprises three-dimensional (3D) data, and wherein at least one of the plurality of selectivity kernels is a 3D spatial selectivity kernel.
Clause 7: A method in accordance with any one of Clauses 1-6, wherein the ML model is trained using a loss function that imposes multiple loss terms, wherein each loss term of the multiple loss terms corresponds to a different one of the plurality of selectivity kernels.
Clause 8: A method in accordance with Clause 7, wherein training the ML model comprises: associating a first selectivity kernel to a first loss term corresponding to a first type of selectivity; associating a second selectivity kernel to a second loss term corresponding to a second type of selectivity; and training the first and second selectivity kernels using the first and second loss terms.
Clause 9: A method in accordance with any one of Clauses 1-8, further comprising select the plurality of selectivity kernels based on content of the input data.
Clause 10: A method in accordance with Clause 9, wherein selecting the plurality of selectivity kernels based on content of the input data comprises: analyzing the content of the input data; determining a complexity of the content; and selecting the plurality of selectivity kernels based on the determined complexity.
Clause 11: A method in accordance with any one of Clauses 1-10, wherein the input data comprises a plurality of frames, and the method further comprises: determining a complexity of each frame of the plurality of frames; and applying different selectivity kernels to different frames based on the determined complexity of each frame.
Clause 12: A method in accordance with Clause 11, wherein determining the complexity of each frame of the plurality of frames comprises one or more of: analyzing one or more of spatial details, edges, or textures within the frame; analyzing one or more of temporal details, motion, or changes between consecutive frames; analyzing one or more objects within the frame; analyzing an overall scene composition or content of the frame; or using a machine learning model trained to estimate frame complexity based on one or more extracted features of the frame.
Clause 13: A method in accordance with any one of Clauses 1-12, wherein the input data comprises data at a plurality of pyramid levels, and wherein different selectivity kernels are applied at different pyramid levels.
Clause 14: A method in accordance with Clause 13, wherein the different selectivity kernels are applied at different pyramid levels based on a complexity of each pyramid level.
Clause 15: A method in accordance with any one of Clauses 1-14, wherein the input data comprises at least one of a disparity map, a depth map, a segmentation map, or an optical flow map.
Clause 16: A method in accordance with any one of Clauses 1-14, wherein each kernel of the plurality of kernels is orthogonal to each of the other kernels in the plurality of kernels.
Clause 17: A method in accordance with any one of Clauses 1-16, further comprising receiving the input data at a modem coupled to one or more antennas and one or more processors.
Clause 18: A method in accordance with Clause 17, wherein the modem and the one or more antennas are integrated into at least one of a vehicle, an extra-reality device, or a mobile device.
Clause 19: A method for performing disparity estimation, comprising: determining to perform standalone disparity estimation or disparity upsampling based disparity estimation of the scene based on the complexity of the scene; and performing disparity estimation of the scene based on the determination.
Clause 20: A method in accordance with Clause 19, wherein to determining to perform standalone disparity estimation or disparity upsampling based disparity estimation comprises: comparing the complexity of the scene to a threshold; if the complexity satisfies the threshold, determining to perform standalone disparity estimation; and if the complexity does not satisfy the threshold, determining to perform disparity upsampling based disparity estimation.
Clause 21: A method in accordance with any one of Clauses 19-20, wherein the complexity of the scene is based on one or more of: a number of objects in the scene, a level of motion in the scene, or a level of lighting in the scene.
Clause 22: A method in accordance with any one of Clauses 19-21, wherein performing the disparity estimation comprises performing disparity upsampling based disparity estimation using a machine learning model comprising a plurality of selectivity kernels, wherein each selectivity kernel is configured to perform a different type of selectivity for upsampling.
Clause 23: A method in accordance with Clause 22, wherein a first selectivity kernel of the plurality of selectivity kernels is configured to perform geometric consistency selectivity based on a geometric consistency kernel (GCK), and wherein a second selectivity kernel of the plurality of selectivity kernels is configured to perform temporal consistency selectivity based on a spatiotemporal selectivity kernel.
Clause 24: A method in accordance with Clause 23, wherein a third selectivity kernel of the plurality of selectivity kernels is configured to perform estimation confidence selectivity based on an estimation confidence kernel (ECK).
Clause 25: A method in accordance with Clause 22, wherein performing disparity estimation of the scene based on the determination comprises obtaining output data, corresponding to input data of the scene, from a machine-learning model, wherein the output data is based on a composite of outputs from the plurality of selectivity kernels.
Clause 26: A method in accordance with Clause 25, wherein the plurality of selectivity kernels are configured to perform selectivity based on at least one of feature similarity, spatial distance, geometric consistency, temporal consistency, or estimation confidence.
Clause 27: A method in accordance with any one of Clauses 19-26, further comprising: receiving second information indicating complexity of a second scene; determining to perform standalone disparity estimation or disparity upsampling based disparity estimation of the second scene based on the complexity of the second scene; and performing disparity estimation of the second scene based on the determination for the second scene.
Clause 28: A method in accordance with Clause 27, wherein standalone disparity estimation is performed for a first scene and disparity upsampling based disparity estimation is performed for a second scene.
Clause 29: A method in accordance with any one of Clauses 19-28, wherein determining to perform standalone disparity estimation or disparity upsampling based disparity estimation is further based on at least one of a level of accuracy or a computational efficiency.
Clause 30: A method in accordance with any one of Clauses 19-28, wherein to determine to perform standalone disparity estimation or disparity upsampling based disparity estimation of the scene based on the complexity of the scene comprises to determine to perform standalone disparity estimation or disparity upsampling based disparity estimation of the scene, at one or more pyramid levels, based on the complexity of the scene, wherein a pyramid level represents a downsampled version of an image at a particular resolution in an image pyramid, and wherein the image pyramid represents a multi-resolution representation of the scene.
Clause 31: A method in accordance with any one of Clauses 19-30, further comprising receive the information indicating complexity of the scene at a modem coupled to one or more antennas and one or more processors.
Clause 32: A method in accordance with Clause 31, wherein the modem and the one or more antennas are integrated into at least one of a vehicle, an extra-reality device, or a mobile device.
Clause 33: A method for upsampling input data, comprising: inputting input data at a first resolution into a machine learning (ML) model configured to perform multiple types of feature selectivity to upsample the input data; and obtaining output data, corresponding to the input data, at a second resolution, from the ML model, the second resolution being higher than the first resolution, wherein the output data is based on a composite of the multiple types of feature selectivity.
Clause 34: A method in accordance with Clause 33, wherein the ML model comprises a plurality of selectivity kernels.
Clause 35: A method in accordance with Clause 34, wherein the input data comprises data for a plurality of modalities, and wherein each kernel of the selectivity kernels is configured to take as input, input data corresponding to a modality of the plurality of modalities.
Clause 36: A method in accordance with Clause 35, wherein the plurality of modalities comprises two or more of: RGB data, LIDAR data, audio data, event camera data, RF data, Ultrasonic data, or Infra-red data.
Clause 37: A method in accordance with any one of Clauses 33-36, wherein a first selectivity kernel of the plurality of selectivity kernels is configured to perform one of geometric consistency selectivity, temporal consistency selectivity, or estimation confidence selectivity.
Clause 38: A method in accordance with Clause 37, wherein a second selectivity kernel of the plurality of selectivity kernels is configured to perform one of feature similarity selectivity or spatial distance selectivity.
Clause 39: A method in accordance with any one of Clauses 33-38, wherein the input data comprises three-dimensional (3D) data, and wherein at least one of the plurality of selectivity kernels is a 3D spatial selectivity kernel.
Clause 40: A method in accordance with any one of Clauses 33-39, wherein the ML model is trained using a loss function that imposes multiple loss terms, wherein each loss term of the multiple loss terms corresponds to a different one of the plurality of selectivity kernels.
Clause 41: A method in accordance with Clause 40, wherein training the ML model comprises: associating a first selectivity kernel to a first loss term corresponding to a first type of selectivity; associating a second selectivity kernel to a second loss term corresponding to a second type of selectivity; and training the first and second selectivity kernels using the first and second loss terms.
Clause 42: A method in accordance with any one of Clauses 33-41, further comprising select the plurality of selectivity kernels based on content of the input data.
Clause 43: A method in accordance with Clause 42, wherein selecting the plurality of selectivity kernels based on content of the input data comprises: analyzing the content of the input data; determining a complexity of the content; and selecting the plurality of selectivity kernels based on the determined complexity.
Clause 44: A method in accordance with any one of Clauses 33-43, wherein the input data comprises a plurality of frames, and the method further comprises: determining a complexity of each frame of the plurality of frames; and applying different selectivity kernels to different frames based on the determined complexity of each frame.
Clause 45: A method in accordance with Clause 44, wherein determining the complexity of each frame of the plurality of frames comprises one or more of: analyzing one or more of spatial details, edges, or textures within the frame; analyzing one or more of temporal details, motion, or changes between consecutive frames; analyzing one or more objects within the frame; analyzing an overall scene composition or content of the frame; or using a machine learning model trained to estimate frame complexity based on one or more extracted features of the frame.
Clause 46: A method in accordance with any one of Clauses 33-45, wherein the input data comprises data at a plurality of pyramid levels, and wherein different types of selectivity are applied at different pyramid levels.
Clause 47: A method in accordance with Clause 46, wherein the different types of selectivity applied at different pyramid levels are based on a complexity of each pyramid level.
Clause 48: A method in accordance with any one of Clauses 33-47, wherein the input data comprises at least one of a disparity map, a depth map, a segmentation map, or an optical flow map.
Clause 49: A method in accordance with any one of Clauses 33-48, wherein each kernel of the plurality of kernels is orthogonal to each of the other kernels in the plurality of kernels.
Clause 50: A method in accordance with any one of Clauses 33-49, further comprising receiving the input data at a modem coupled to one or more antennas and one or more processors.
Clause 51: A method in accordance with Clause 50, wherein the modem and the one or more antennas are integrated into at least one of a vehicle, an extra-reality device, or a mobile device.
Clause 52: One or more apparatuses, comprising: one or more memories comprising executable instructions; and one or more processors configured to execute the executable instructions and cause the one or more apparatuses to perform a method in accordance with any one of clauses 1-51.
Clause 53: One or more apparatuses, comprising: one or more memories; and one or more processors, coupled to the one or more memories, configured to cause the one or more apparatuses to perform a method in accordance with any one of Clauses 1-51.
Clause 54: One or more apparatuses, comprising: one or more memories; and one or more processors, coupled to the one or more memories, configured to perform a method in accordance with any one of Clauses 1-51.
Clause 55: One or more apparatuses, comprising means for performing a method in accordance with any one of Clauses 1-51.
Clause 56: One or more non-transitory computer-readable media comprising executable instructions that, when executed by one or more processors of one or more apparatuses, cause the one or more apparatuses to perform a method in accordance with any one of Clauses 1-51.
Clause 57: One or more computer program products embodied on one or more computer-readable storage media comprising code for performing a method in accordance with any one of Clauses 1-51.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured to upsample input data, comprising:
one or more memories configured to store input data; and
one or more processors, coupled to the one or more memories, configured to:
input the input data at a first resolution into a machine learning (ML) model comprising a plurality of selectivity kernels, each of the plurality of selectivity kernels configured to perform a different type of selectivity to upsample the input data; and
obtain output data, corresponding to the input data, at a second resolution, from the ML model, the second resolution being higher than the first resolution, wherein the output data is based on a composite of outputs from the plurality of selectivity kernels.

2. The apparatus of claim 1, wherein the input data comprises data for a plurality of modalities, and wherein each kernel of the selectivity kernels is configured to take as input, input data corresponding to a different modality of the plurality of modalities.

3. The apparatus of claim 2, wherein the plurality of modalities comprises two or more of: RGB data, LIDAR data, audio data, event camera data, Radio Frequency (RF) data, Ultrasonic data, or Infra-red data.

4. The apparatus of claim 1, wherein a first selectivity kernel of the plurality of selectivity kernels is configured to perform a first type of selectivity comprising geometric consistency selectivity, temporal consistency selectivity, or estimation confidence selectivity.

5. The apparatus of claim 4, wherein a second selectivity kernel of the plurality of selectivity kernels is configured to perform a second type of selectivity comprising feature similarity selectivity or spatial distance selectivity.

6. The apparatus of claim 1, wherein the input data comprises three-dimensional (3D) data, and wherein at least one of the plurality of selectivity kernels is a 3D spatial selectivity kernel.

7. The apparatus of claim 1, wherein the ML model is trained using a loss function that imposes multiple loss terms, wherein each loss term of the multiple loss terms corresponds to a different one of the plurality of selectivity kernels.

8. The apparatus of claim 7, wherein the one or more processors are configured to train the ML model, wherein to train the ML model comprises to:
associate a first selectivity kernel to a first loss term corresponding to a first type of selectivity;
associate a second selectivity kernel to a second loss term corresponding to a second type of selectivity; and
train the first and second selectivity kernels using the first and second loss terms.

9. The apparatus of claim 1, wherein the one or more processors are configured to select the plurality of selectivity kernels based on content of the input data.

10. The apparatus of claim 9, wherein to select the plurality of selectivity kernels based on content of the input data comprises to:
analyze the content of the input data;
determine a complexity of the content; and
select the plurality of selectivity kernels based on the determined complexity.

11. The apparatus of claim 1, wherein the input data comprises a plurality of frames, and wherein the one or more processors are configured to:
determine a complexity of each frame of the plurality of frames; and
apply different selectivity kernels to different frames based on the determined complexity of each frame.

12. The apparatus of claim 11, wherein to determine the complexity of each frame of the plurality of frames comprises one or more of:
to analyze one or more of spatial details, edges, or textures within the frame;
to analyze one or more of temporal details, motion, or changes between consecutive frames;
to analyze one or more objects within the frame;
to analyze an overall scene composition or content of the frame; or
to use a machine learning model trained to estimate frame complexity based on one or more extracted features of the frame.

13. The apparatus of claim 1, wherein the input data comprises data at a plurality of pyramid levels, and wherein different selectivity kernels are applied at different pyramid levels.

14. The apparatus of claim 13, wherein the different selectivity kernels are applied at different pyramid levels based on a complexity of each pyramid level.

15. The apparatus of claim 1, wherein the input data comprises at least one of a disparity map, a depth map, a segmentation map, or an optical flow map.

16. The apparatus of claim 1, further comprising a modem, coupled to one or more antennas, and coupled to the one or more processors, wherein the modem and the one or more antennas are configured to receive the input data.

17. The apparatus of claim 16, wherein the modem and the one or more antennas are integrated into at least one of a vehicle, an extra-reality device, or a mobile device.

18. An apparatus configured to perform disparity estimation, comprising:
one or more memories configured to store information indicating complexity of a scene; and
one or more processors, coupled to the one or more memories, configured to:
determine to perform standalone disparity estimation or disparity upsampling based disparity estimation of the scene based on the complexity of the scene; and
perform disparity estimation of the scene based on the determination.

19. The apparatus of claim 18, wherein to determine to perform standalone disparity estimation or disparity upsampling based disparity estimation comprises:
to compare the complexity of the scene to a threshold;
if the complexity satisfies the threshold, determine to perform standalone disparity estimation; and
if the complexity does not satisfy the threshold, determine to perform disparity upsampling based disparity estimation.

20. The apparatus of claim 18, wherein the complexity of the scene is based on one or more of:
a number of objects in the scene,
a level of motion in the scene, or
a level of lighting in the scene.

21. The apparatus of claim 18, wherein to perform the disparity estimation comprises to perform disparity upsampling based disparity estimation using a machine learning model comprising a plurality of selectivity kernels, wherein each selectivity kernel is configured to perform a different type of selectivity for upsampling.

22. The apparatus of claim 21, wherein a first selectivity kernel of the plurality of selectivity kernels is configured to perform geometric consistency selectivity based on a geometric consistency kernel (GCK), and wherein a second selectivity kernel of the plurality of selectivity kernels is configured to perform temporal consistency selectivity based on a spatiotemporal selectivity kernel.

23. The apparatus of claim 22, wherein a third selectivity kernel of the plurality of selectivity kernels is configured to perform estimation confidence selectivity based on an estimation confidence kernel (ECK).

24. The apparatus of claim 21, wherein to perform disparity estimation of the scene based on the determination comprises to obtain output data, corresponding to input data of the scene, from a machine-learning model, wherein the output data is based on a composite of outputs from the plurality of selectivity kernels.

25. The apparatus of claim 24, wherein the plurality of selectivity kernels are configured to perform selectivity based on at least one of feature similarity, spatial distance, geometric consistency, temporal consistency, or estimation confidence.

26. The apparatus of claim 18, wherein the one or more processors are configured to:
receive second information indicating complexity of a second scene;
determine to perform standalone disparity estimation or disparity upsampling based disparity estimation of the second scene based on the complexity of the second scene; and
perform disparity estimation of the second scene based on the determination for the second scene.

27. The apparatus of claim 26, wherein standalone disparity estimation is performed for a first scene and disparity upsampling based disparity estimation is performed for a second scene.

28. The apparatus of claim 18, wherein to determine to perform standalone disparity estimation or disparity upsampling based disparity estimation is further based on at least one of a level of accuracy or a computational efficiency.

29. The apparatus of claim 18, further comprising a modem, coupled to one or more antennas, and coupled to the one or more processors, wherein the modem and the one or more antennas are configured to receive the information indicating complexity of the scene.

30. The apparatus of claim 28, wherein the modem and the one or more antennas are integrated into at least one of a vehicle, an extra-reality device, or a mobile device.
